(19) United States
(12) Patent Application Publication
(10) Pub. No.: US 2025/0094206 A1
(43) Pub. Date: Mar. 20, 2025

(54) MONITORING DEVICE AND MONITORING METHOD

(71) Applicant: Panasonic Automotive Systems Co., Ltd., Kanagawa (JP)

(72) Inventors: Ryo HIRANO, Kanagawa (JP); Yoshiharu IMAMOTO, Kanagawa (JP)

(73) Assignee: Panasonic Automotive Systems Co., Ltd., Kanagawa (JP)

(21) Appl. No.: 18/965,204

(22) Filed: Dec. 2, 2024

Related U.S. Application Data
(63) Continuation of application No. PCT/JP2023/004470, filed on Feb. 9, 2023.

(30) Foreign Application Priority Data
Jun. 10, 2022 (JP) 2022-094337

(51) Int. Cl. G06F 9/455

(52) U.S. Cl. CPC G06F 9/45558; G06F 2009/45591

(57) ABSTRACT

A monitoring device runs on a first virtual machine in which one or more monitoring programs operate, the first virtual machine being included in the two or more virtual machines, the one or more monitoring programs being for monitoring a command. The monitoring device includes a processor and a non-transitory memory. The processor executes a program to cause the monitoring device to operate as: a command receiver that receives a command transmitted or received in a process operating in a second virtual machine; a configuration information obtainer that obtains configuration information on the second virtual machine; a monitoring program controller that determines an execution method for executing the one or more monitoring programs, according to the configuration information and the feature of the command; and an anomaly responder that sends notice of an anomaly when the anomaly is included in a result of monitoring the command.

### CROSS REFERENCE TO RELATED APPLICATIONS

This is a continuation application of PCT International Application No. PCT/JP2023/004470 filed on Feb. 9, 2023, designating the United States of America, which is based on and claims priority of Japanese Patent Application No. 2022-094337 filed on Jun. 10, 2022.

### FIELD

The present disclosure relates to a monitoring device and a monitoring method for monitoring, for example, a command.

### BACKGROUND

A monitoring device according to Patent Literature 1 (PTL 1) uses a virtual machine responsible for monitoring on a virtualization software to monitor virtual machines being monitored on the virtualization software. For example, at predetermined time intervals, the monitoring device inspects the virtual machines being monitored and the hypervisor from the virtual machine responsible for monitoring and obtains a result of the inspection.

### CITATION LIST

### Patent Literature

PTL 1: Japanese Unexamined Patent Application Publication No. 2019-144785

### SUMMARY

However, the monitoring device according to PTL 1 described above can be improved upon. Hence, the present disclosure provides a monitoring device and the like that are capable of improving upon the above related art.

A monitoring device according to one aspect of the present disclosure is a monitoring device in a virtualization platform that causes two or more virtual machines to operate, wherein the monitoring device runs on a first virtual machine in which one or more monitoring programs operate, the first virtual machine being included in the two or more virtual machines, the one or more monitoring programs being for monitoring a command transmitted or received in a process, the monitoring device comprises: a processor; and a non-transitory memory in which a program is stored, and the processor executes the program to cause the monitoring device to operate as: a command receiver that receives a command transmitted or received in a process operating in a second virtual machine different from the first virtual machine; a configuration information obtainer that obtains configuration information on the second virtual machine; a monitoring program controller that refers to a feature of the command from an identifier included in the command, and determines an execution method for executing the one or more monitoring programs, according to the configuration information and the feature of the command; and an anomaly responder that obtains a result of the monitoring performed by executing the one or more monitoring programs, and sends notice of an anomaly when the anomaly is included in the result.

It should be noted that these general or specific aspects may be implemented as a system, a method, an integrated circuit, a computer program, or a computer-readable recording medium such as a CD-ROM, or any combination of systems, methods, integrated circuits, computer programs, or computer-readable recording media. In addition, a recording medium may be a non-transitory recording medium.

A monitoring device and the like according to an aspect of the present disclosure are capable of improving upon the above related art.

The Specification and the Drawings clarify further advantages and advantageous effects according to one aspect of the present disclosure. Such advantages and/or advantageous effects are yielded by features of some embodiments and features described in the Specification and illustrated in the Drawings, yet not all are necessarily provided in order to obtain the advantages and the advantageous effects.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a general configuration diagram of a monitoring system in an embodiment.

FIG. 2 is a configuration diagram illustrating an in-vehicle system in the embodiment.

FIG. 3 is a configuration diagram of an integrated ECU in the embodiment.

FIG. 4 is a block diagram illustrating a configuration of part of the integrated ECU in the embodiment in detail.

FIG. 5 is a table showing an example of virtual commands in the embodiment.

FIG. 6 is a table showing an example of pieces of configuration information on virtual machines in the embodiment.

FIG. 7 is a table showing an example of system statuses of virtual machines in the embodiment.

FIG. 8 is a diagram illustrating an example of a processing sequence by a monitoring virtual machine in the embodiment.

FIG. 9 is a diagram illustrating an example of a flowchart of processing of determining one or more monitoring programs in the embodiment.

FIG. 10 is a diagram illustrating an example of a flowchart of processing of invoking the one or more monitoring programs in the embodiment.

FIG. 11 is a diagram illustrating an example of a flowchart of processing of determining a time-out time of the one or more monitoring programs in the embodiment.

FIG. 12 is a diagram illustrating another example of the flowchart of the processing of determining the one or more monitoring programs in the embodiment.

FIG. 13 is a diagram illustrating an example of a flowchart of processing of determining a sequence of the one or more monitoring programs and processing of executing the one or more monitoring programs in the embodiment.

FIG. 14 is a diagram illustrating an example of a flowchart of anomaly response processing in the embodiment.

FIG. 15 is a table showing an example of a grouped log in the embodiment.

FIG. 16 is a table showing an example of the grouped log in the embodiment.

FIG. 17 is a diagram illustrating an example of monitoring result display in the embodiment.

FIG. 18 is a diagram illustrating an example of the monitoring result display in the embodiment.

FIG. 19 is a block diagram illustrating a configuration of part of an integrated ECU in a variation in detail.

FIG. 20 is a diagram illustrating an example of a processing sequence by a monitoring virtual machine in the variation.

FIG. 21 is a diagram illustrating an example of a flowchart of processing for sharing between monitoring programs in the variation.

FIG. 22 is a table showing an example of a determination table for the sharing in the variation.

### DESCRIPTION OF EMBODIMENT

### Underlying Knowledge Forming Basis of the Present Disclosure

The monitoring device according to PTL 1 described above can detect, unless the virtual machine responsible for monitoring is hacked, an anomaly in another virtual machine. However, the inspection is periodic. Thus, it is difficult to respond to unauthorized file operation or network communication during a period between inspection intervals, and missing detection may occur.

In order to solve such a problem, a monitoring device according to one aspect of the present disclosure is a monitoring device in a virtualization platform that causes two or more virtual machines to operate. The monitoring device runs on a first virtual machine in which one or more monitoring programs operate, the first virtual machine being included in the two or more virtual machines, the one or more monitoring programs being for monitoring a command transmitted or received in a process. The monitoring device comprises: a processor; and a non-transitory memory in which a program is stored, and the processor executes the program to cause the monitoring device to operate as: a command receiver that receives a command transmitted or received in a process operating in a second virtual machine different from the first virtual machine; a configuration information obtainer that obtains configuration information on the second virtual machine; a monitoring program controller that refers to a feature of the command from an identifier included in the command, and determines an execution method for executing the one or more monitoring programs, according to the configuration information and the feature of the command; and an anomaly responder that obtains a result of the monitoring performed by executing the one or more monitoring programs, and sends notice of an anomaly when the anomaly is included in the result.

Accordingly, the execution method for executing the one or more monitoring programs is determined according to the configuration information on the second virtual machine and the feature of the command, and thus it is possible to execute monitoring processing appropriate for a feature of the second virtual machine and the feature of the command. Thus, it is possible to adjust a processing load of the monitoring processing. In addition, it is possible to implement monitoring processing with consideration given to a real-time performance of a command and to thus execute the monitoring processing on a command effectively.

Moreover, the processor may further cause the monitoring device to operate as a system status obtainer that obtains a system status of the second virtual machine, and the monitoring program controller may further determine the execution method for executing the one or more monitoring programs, according to the system status.

Accordingly, the execution method for executing the one or more monitoring programs is further determined according to the system status of the second virtual machine, and thus it is possible to execute monitoring processing appropriate for a status of the second virtual machine. Thus, it is possible to adjust a processing load of the monitoring processing. In addition, it is possible to implement monitoring processing with consideration given to a real-time performance of a command and to thus execute the monitoring processing on a command effectively.

Furthermore, the feature of the command may be at least one of the following: a virtual machine at a transmission source or a transmission destination of the command; an electronic control unit at the transmission source or the transmission destination of the command; a transmission direction of the command; an access destination of a file operation included in the command; a type of the file operation included in the command; a type of an operating system (OS) of the virtual machine at the transmission source or the transmission destination; presence or absence of an external connecting function of the virtual machine at the transmission source or the transmission destination; an automotive safety integrity level (ASIL) of the command; or an influence of the command on vehicle control.

Thus, it is possible to execute monitoring processing appropriate for the feature of the second virtual machine and the feature of the command.

Moreover, the system status is at least one of the following: a traveling state of a vehicle including the monitoring device; a traveling mode of the vehicle; a system load of a virtual machine; a system load in processing the command; a network connection state of the virtual machine; presence or absence of a security anomaly in the virtual machine; or presence or absence of a security anomaly in a virtual command.

Furthermore, the execution method for executing the one or more monitoring programs may be at least one of the following: whether the one or more monitoring programs are active; a method for invoking the one or more monitoring programs; a time-out time set to the one or more monitoring programs; or an execution sequence of the one or more monitoring programs.

Thus, it is possible to adjust a processing load of the monitoring processing. In addition, it is possible to implement monitoring processing with consideration given to a real-time performance of a command.

Moreover, the anomaly responder may further aggregate or add up logs each of which indicates an anomaly in the command, according to the feature of the command.

Thus, it is possible to use aggregated or added-up anomalies in an analysis.

Furthermore, based on a result of monitoring performed by executing a simplified monitoring program, the monitoring program controller may invoke a detailed monitoring program that has a processing load higher than a processing load of the simplified monitoring program, the simplified monitoring program and the detailed monitoring program being included in the one or more monitoring programs.

Moreover, the processor may further cause the monitoring device to operate as two or more monitoring program controllers, the two or more monitoring program controllers each being the monitoring program controller, and when a transmission destination of the command is determined to be a virtual machine on the virtualization platform, the execution method for executing the one or more monitoring programs may be determined by, among the two or more monitoring program controllers, one or more monitoring program controllers determined based on the identifier included in the command and the configuration information.

Thus, it is possible to cause the two or more monitoring program controllers to share the monitoring processing, based on the identifier included in the command and the configuration information. Therefore, the delay can be reduced.

Furthermore, the two or more monitoring program controllers may determine the execution method for executing the one or more monitoring programs, according to a system status of the second virtual machine.

Moreover, among the two or more monitoring program controllers, a first monitoring program controller may assign a first identifier to the command, and a second monitoring program controller may determine the execution method for executing the one or more monitoring programs, according to whether the first identifier has been assigned to the command.

A monitoring method according to one aspect of the present disclosure is a monitoring method to be executed by a monitoring device in a virtualization platform that causes two or more virtual machines to operate. The monitoring device runs on a first virtual machine in which one or more monitoring programs operate, the first virtual machine being included in the two or more virtual machines, the one or more monitoring programs being for monitoring a command transmitted or received in a process. The monitoring method comprises: receiving a command transmitted or received in a process operating in a second virtual machine different from the first virtual machine; obtaining configuration information on the second virtual machine; referring to a feature of the command from an identifier included in the command, and determining an execution method for executing the one or more monitoring programs, according to the configuration information and the feature of the command; and obtaining a result of the monitoring performed by executing the one or more monitoring programs, and sending notice of an anomaly when the anomaly is included in the result.

Accordingly, the execution method for executing the one or more monitoring programs is determined according to the configuration information on the second virtual machine and the feature of the command, and thus it is possible to execute monitoring processing appropriate for a feature of the second virtual machine and the feature of the command. Thus, it is possible to adjust a processing load of the monitoring processing. In addition, it is possible to implement monitoring processing with consideration given to a real-time performance of a command and to thus execute the monitoring processing on a command effectively.

Hereinafter, an embodiment is described in detail with reference to the drawings.

It should be noted that each of the embodiments described below shows a generic or specific example. Numerical values, shapes, materials, constituent elements, the arrangement and connection of the constituent elements, steps, the order of the steps, etc. shown in the following embodiments are mere examples, and are not intended to limit the scope of the present disclosure. Moreover, among the constituent elements in the following embodiments, those not recited in any of the independent claims defining the broadest concept are described as optional constituent elements.

Furthermore, the respective figures are schematic diagrams and are not necessarily precise illustrations.

Additionally, in the respective figures, identical constituent components are given the same reference signs.

### Embodiment

### [General Configuration Diagram of Monitoring System]

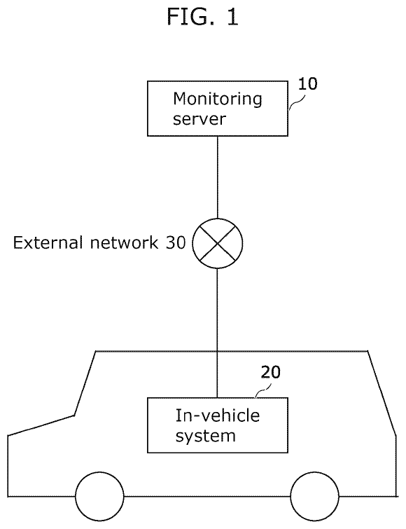

FIG. 1 is a general configuration diagram of a monitoring system in an embodiment.

The monitoring system includes monitoring server 10 and in-vehicle system 20. Monitoring server 10 and in-vehicle system 20 are connected together via external network 30.

External network 30 is, for example, the Internet. A communication method of external network 30 may be either a wired or wireless one. A wireless communication system may be Wi-Fi (registered trademark), 3G/long term evolution (LTE), Bluetooth (registered trademark), or V2X communication system, which are existing technologies.

Monitoring server 10 is a device that obtains, from in-vehicle system 20, a monitoring result that is information about a security status of in-vehicle system 20 and displays the monitoring result through a graphical user interface. For example, in a security operation center, monitoring server 10 is used by a security analyst checking a result of monitoring and considering taking measures such as updating software when an anomaly occurs in in-vehicle system 20.

In-vehicle system 20 is a device that performs controlling communication, controlling a vehicle, outputting an image, and the like, monitors the security status of in-vehicle system 20, and sends notice of a result of monitoring the security status to monitoring server 10. Although FIG. 1 illustrates only one in-vehicle system 20, each of one or more in-vehicle systems 20 transmits a result of monitoring the security status to monitoring server 10. In-vehicle system 20 will be described below in detail.

### [General Configuration Diagram of In-Vehicle System 20]

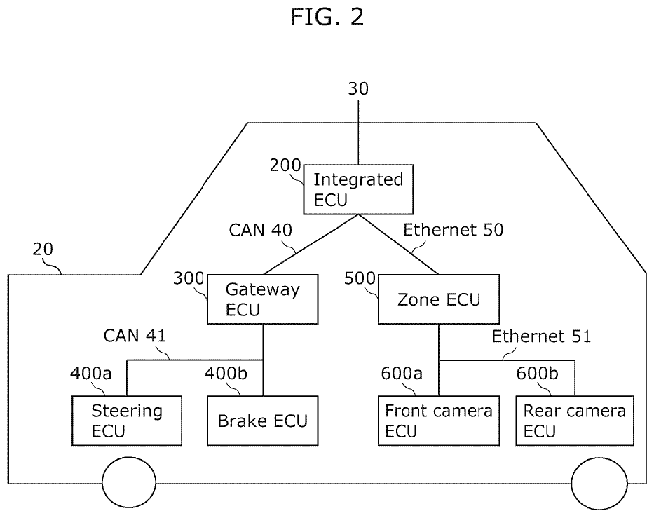

FIG. 2 is a configuration diagram illustrating the in-vehicle system in the embodiment.

In-vehicle system 20 includes integrated ECU 200, gateway ECU 300, steering ECU 400a, brake ECU 400b, Zone ECU 500, front camera ECU 600a, and rear camera ECU 600b.

Integrated ECU 200 and gateway ECU 300 are connected together via CAN 40, which is a control area network (CAN), a type of network protocol. The network protocol used here is not limited to the CAN and may be a network protocol used in the in-vehicle system, such as CAN-FD or FlexRay protocol.

Gateway ECU 300, steering ECU 400a, and brake ECU 400b are connected together via CAN 41.

Integrated ECU 200 and Zone ECU 500 are connected together via Ethernet 50, which is a protocol based on Ethernet (registered trademark), a type of a network protocol. Ethernet 50 is, for example, Scalable service-Oriented MiddlewarE over Ip (SOME/IP) protocol. The network protocol used here is not limited to the SOME/IP and may be a network protocol used in the in-vehicle system, such as SOME/IP-SD or CAN-XL.

Zone ECU 500, front camera ECU 600a, and rear camera ECU 600b are connected together via Ethernet 51. Ethernet 51 may be based on the same network protocol as Ethernet 50 or based on a different network protocol.

Integrated ECU 200 and monitoring server 10 are connected together via external network 30.

Integrated ECU 200 is an ECU that performs communication control that transmits and receives messages via external network 30, CAN 40, and Ethernet 50, vehicle control that instructs, via CAN 40 and Ethernet 50, gateway ECU 300 and Zone ECU 500 to control the vehicle, and image output to an infotainment system or an instrument panel. Integrated ECU 200 is also an ECU that monitors a security status of integrated ECU 200 and sends notice of a result of the monitoring to monitoring server 10. Note that integrated ECU 200 in the present embodiment is an example of a monitoring device and will be described later in detail.

Gateway ECU 300 is an ECU that mediates messages that are transmitted and received between integrated ECU 200, and steering ECU 400a and brake ECU 400b.

Steering ECU 400a is an ECU that controls steering using a steering wheel provided to the vehicle.

Brake ECU 400b is an ECU that controls brakes provided to the vehicle.

In-vehicle system 20 performs control such as traveling, turning, and stopping of the vehicle by using ECUs controlling an engine and a body of the vehicle, as well as steering ECU 400a and brake ECU 400b.

Zone ECU 500 is an ECU that mediates messages transmitted and received between integrated ECU 200, and front camera ECU 600a and rear camera ECU 600b.

Front camera ECU 600a is an ECU that obtains an image from a camera provided in a front part of the vehicle and capturing an image of a front of the vehicle.

Rear camera ECU 600b is an ECU that obtains an image from a camera provided in a rear part of the vehicle and capturing an image of a rear of the vehicle.

Although FIG. 2 illustrates only the front camera ECU and the rear camera ECU, an advanced driver assistance system such as automated driving, adaptive cruise control, or automated parking may be implemented using an ECU that collects information from various sensors such as GPS.

### [Configuration Diagram of Integrated ECU]

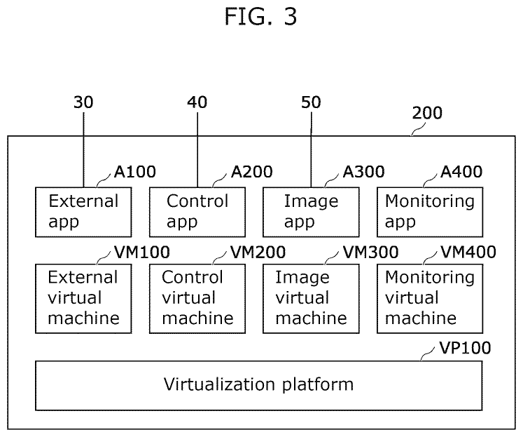

FIG. 3 is a configuration diagram of integrated ECU 200 in the embodiment. Integrated ECU 200 includes external application A100, control application A200, image application A300, external virtual machine VM100, control virtual machine VM200, image virtual machine VM300, virtualization platform VP100, monitoring application A400, and monitoring virtual machine VM400. Hereinafter, external application A100, control application A200, and image application A300 may be collectively referred to as an application. In addition, external virtual machine VM100, control virtual machine VM200, image virtual machine VM300, and monitoring virtual machine VM400 may be collectively referred to as a virtual machine.

Virtualization platform VP100 is a virtualization software foundation such as a hypervisor. Virtualization platform VP100 is software that executes and manages one or more virtual machines. In general, hypervisors are classified into bare-metal hypervisors called Type-1 and hosted hypervisors called Type-2. In embedded systems, Type-1 is generally used with consideration given to overhead of processing by the hypervisor. Type-1 hypervisors have small code sizes and are thus unlikely to involve vulnerability, and the hypervisors can be supposed to be reliable compared with applications and virtual machines.

The embodiment will be described with an example in which a virtualization system is implemented by a Type-1 hypervisor. However, the virtualization system may be implemented by a Type-2 hypervisor.

External virtual machine VM100 is an operating system that causes external application A100 to operate. External application A100 is an application software program that communicates with monitoring server 10 via external network 30.

Control virtual machine VM200 is an operating system that causes control application A200 to operate. Control application A200 is an application software program that communicates with gateway ECU 300 via CAN 40 to control operation pertaining to traveling of a vehicle including in-vehicle system 20.

Image virtual machine VM300 is an operating system that causes image application A300 to operate. Image application A300 is an application software program that communicates Zone ECU 500 via Ethernet 50 to obtain images or the like from the cameras and to output an image on the infotainment system, the instrument panel, or a head-up display. The images from the cameras are also used as information for implementing the advanced driver assistance system such as automated driving.

Monitoring virtual machine VM400 is an operating system that uses a virtualization driver to cause monitoring application A400 to operate. Monitoring application A400 is an application software program that monitors, for example, virtualization platform 100, the virtual machines other than monitoring virtual machine VM400, and the like.

Note that, for integrated ECU 200 in the present embodiment, for example, paravirtualization technique (virtio) is used. The paravirtualization technique is a technique to provide a standardized interface to virtual machines on virtualization platform 100, thus enabling high-speed communication with physical devices (a storage, a network device, etc.) to which virtualization platform 100 is connected.

Note that integrated ECU 200 may be provided with a function of managing fuel, a power supply status, a fuel supply status, a function of issuing an emergency alert when an anomaly such as an accident occurs in the system, a function of controlling vehicle diagnosis, a function of monitoring connection to an external device, which are however omitted in FIG. 3.

Note that external virtual machine VM100 is relatively likely to be hacked by an attacker because of a downloaded third-party application and connection to the external network such as that based on Wi-Fi® or Bluetooth®. Control virtual machine VM200 transmits and receives commands to perform controlling about traveling, stopping, turning, and the like of an automobile, and thus the commands are required to have a real-time performance. Image virtual machine VM300 controls a display device, thus being required to have a certain level of real-time performance for, for example, displaying a vehicle speed, an image from a camera, and image virtual machine VM300 has no connection to the external network, thus being relatively unlikely to be hacked. For this reason, for image virtual machine VM300, monitoring a received command is needed rather than monitoring a transmitted command. From these, communication in which the external virtual machine is a transmission source requires detailed monitoring, and in a case where the control virtual machine is a transmission source or a transmission destination, simplified monitoring is desired to attain real-time performance.

### [Details of Configuration Diagram of Integrated ECU]

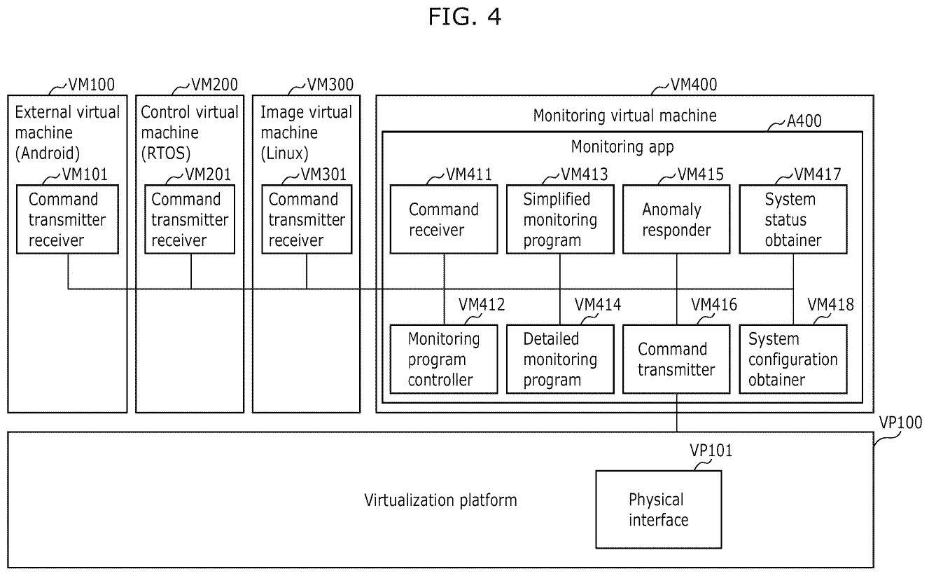

FIG. 4 is a block diagram illustrating a configuration of part of integrated ECU 200 in the embodiment in detail.

External virtual machine VM100 includes command transmitter receiver VM101 that executes transmission and reception of commands. Command transmitter receiver VM101 transmits a command to the virtual machines other than external virtual machine VM100, an external ECU, an external device, and the like. In addition, command transmitter receiver VM101 receives commands from the virtual machines other than external virtual machine VM100, the external ECU, the external device, and the like.

Control virtual machine VM200 includes command transmitter receiver VM201 that executes transmission and reception of commands. Command transmitter receiver VM201 transmits a command to the virtual machines other than control virtual machine VM200, an external ECU, an external device, and the like. In addition, command transmitter receiver VM201 receives commands from the virtual machines other than external virtual machine VM100, the external ECU, the external device, and the like.

Image virtual machine VM300 includes command transmitter receiver VM301 that executes transmission and reception of commands. Command transmitter receiver VM301 transmits a command to the virtual machines other than external virtual machine VM100, an external ECU, an external device, and the like. In addition, command transmitter receiver VM301 receives commands from the virtual machines other than external virtual machine VM100, the external ECU, the external device, and the like.

Monitoring application A400 of monitoring virtual machine VM400 includes command receiver VM411, monitoring program controller VM412, simplified monitoring program VM413, detailed monitoring program VM414, anomaly responder VM415, command transmitter VM416, system status obtainer VM417, and system configuration obtainer VM418.

Command receiver VM411 receives a command from a virtual machine other than monitoring virtual machine VM400, an external ECU, an external device, or the like. Command receiver VM411 obtains a command transmitted or received in a process operating in a target virtual machine (a second virtual machine) that is at least one of the virtual machines other than monitoring virtual machine VM400, that is, external virtual machine VM100, control virtual machine VM200, and image virtual machine VM300.

Monitoring program controller VM412 refers to a feature of the command obtained by command receiver VM411 from an identifier included in the command and determines the feature of the command. Monitoring program controller VM412 then determines an execution method for executing one or more monitoring programs according to the feature of the command and configuration information that indicates a configuration of the target virtual machine obtained by system configuration obtainer VM418. Monitoring program controller VM412 may determine the execution method for executing the one or more monitoring programs additionally according to a system status of the target virtual machine obtained by system status obtainer VM417. Note that the execution method for executing the one or more monitoring programs will be described later in detail.

Simplified monitoring program VM413 is an example of a program that performs simple monitoring on a command obtained by command receiver VM411. For example, simplified monitoring program VM413 may be a program that performs Firewall checking a header field of a packet and filtering the packet using an allowlist or may be a program that performs flow detection in which the program obtains only statistical information on packets and determines an anomaly from a communication traffic volume for each communication pair. That is, the simple monitoring is, for example, Firewall, the flow detection, or the like.

Detailed monitoring program VM414 is an example of a program that performs detailed monitoring on a command obtained by command receiver VM411. Detailed monitoring program VM414 may be, for example, a program that performs Deep packet inspection, which determines whether an anomaly is included in a payload of a command. That is, the detailed monitoring is, for example, Deep packet inspection, or the like.

Although monitoring application A400 is supposed to include simplified monitoring program VM413 and detailed monitoring program VM414, this is not limitative, and monitoring application A400 is only required to include a plurality of monitoring programs of different types. For example, monitoring application A400 may include a file access monitoring program and a network monitoring program. The file access monitoring program is a program that monitors a command pertaining to file access. The file access monitoring program may be, for example, a program that retains paths of files being readable and writable by a specific virtual machine, in a form of an allowlist, and performs processing of determining reading and writing of a file on a path not retained in the allowlist as an anomaly. In this case, as the file access monitoring program, a monitoring program that uses a specific detection rule in accordance with a type of a command can be used. The network monitoring program is a program that monitors a command pertaining to data that is delivered and received via the networks.

Simplified monitoring program VM413 and detailed monitoring program VM414 may be identical monitoring programs retaining different rules.

Anomaly responder VM415 obtains a result of the monitoring performed by executing the monitoring programs and sends notice of an anomaly when the anomaly is included in the result of the monitoring.

Based on a result of monitoring a command, command transmitter VM416 transmits the command to a virtual machine other than monitoring virtual machine VM400, an external ECU, an external device, or the like. When a result of monitoring a command includes an anomaly, command transmitter VM416 does not transmit the command to a destination of the command, and when the result of monitoring the command includes no anomaly, command transmitter VM416 transmits the command to the destination of the command.

System status obtainer VM417 obtains the system status of the target virtual machine. The system status will be described later in detail.

System configuration obtainer VM418 obtains the configuration information on the target virtual machine. System configuration obtainer VM418 is an example of a configuration information obtainer. The configuration information will be described later in detail.

Virtualization platform VP100 includes physical interface VP101. Physical interface VP101 controls communication between monitoring server 10, and external virtual machine VM100, control virtual machine VM200, image virtual machine VM300, and monitoring virtual machine VM400.

### [Virtual Command]

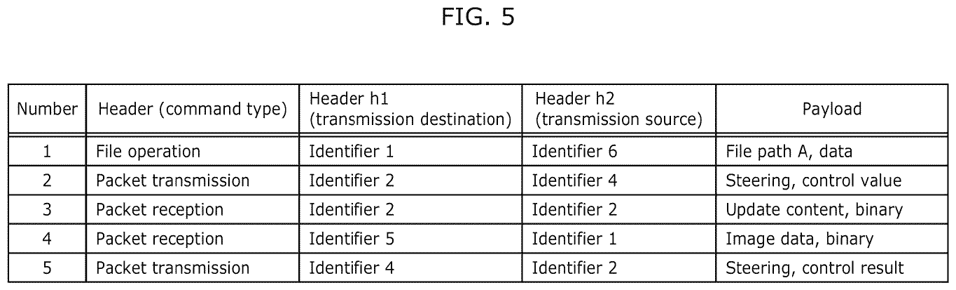

FIG. 5 is a table showing an example of virtual commands in the embodiment.

For example, as shown in FIG. 5, the virtual commands each include a number such as a sequence number, a header indicating a command type, header h1, header h2, and a payload. The header indicating a command type indicates, for example, a file operation, a packet transmission, a packet reception, or the like, as a command type. Header h1 indicates a transmission destination of a virtual command. Header h2 indicates a transmission source of a virtual command. The transmission destination or the transmission source may be a storage device or an external ECU. The payload includes a file path, data, data on steering control, a control value, update content, binary data, and the like. Note that the file operation is classified into two types: data read request and data write request, and information for identifying a type of the file operation may be stored in header h1.

### [Configuration Information of Virtual Machine]

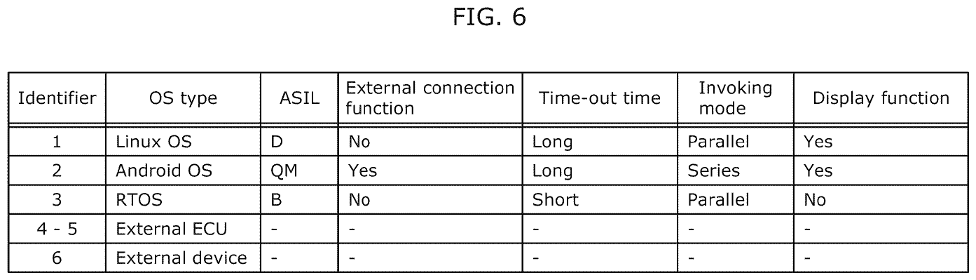

FIG. 6 is a table showing an example of pieces of configuration information on virtual machines in the embodiment. The configuration information is a table for obtaining, for each identifier included in a command, configuration information on a system relating to the identifier.

For example, as shown in FIG. 6, a piece of configuration information on a virtual machine includes an identifier to identify the virtual machine, a type of an operating system (OS) of the virtual machine, an automotive safety integrity level (ASIL), an external connecting function, a time-out time, an invoking mode, and a display function. The ASIL indicates a safety level of an automobile. The external connecting function indicates whether the virtual machine is capable of establishing a communication connection with an external device. The time-out time indicates a time-out time that is set to processing to be performed by a monitoring program. The invoking mode indicates whether a monitoring program is to be executed in series or parallel with transmission-reception processing of a command. That is, in a case of series execution, the monitoring program is to be executed on a command before the transmission-reception processing is executed on the command. In a case of parallel execution, the monitoring program is to be executed on a command in parallel to the execution of the transmission-reception processing on the command. The display function indicates whether the virtual machine has a displaying function.

In the piece of configuration information, the type of the OS and the external connecting function may be used to determine how easy for an attacker to hack the virtual machine. The ASIL may be used to determine a real-time performance of the virtual machine. The ASIL is set to be D, C, B, A, or QM in descending order of level. A higher level of ASIL may be determined as requiring a higher real-time performance. The time-out time is used to set a time-out time to a monitoring program. The invoking mode is used to determine an invoking mode of a monitoring program. The time-out time and the invoking mode may be determined based on the real-time performance rather than for each identifier. The display function may be used to display an anomaly when the anomaly is detected. When occurrence of an anomaly in a virtual machine is suspected, and the virtual machine has the displaying function, the virtual machine may execute processing of displaying the anomaly. As the system is updated, pieces of configuration information on the virtual machines may be subjected to any one of addition, deletion, and change. Also in this case, the monitoring program controller is only required to refer to a table showing updated configuration information.

### [System Status of Virtual Machine]

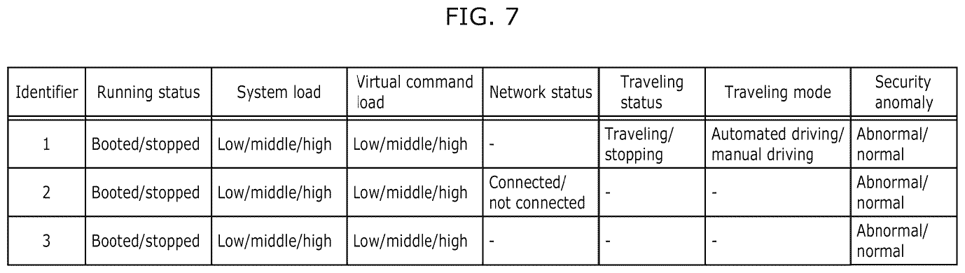

FIG. 7 is a table showing an example of system statuses of virtual machines in the embodiment. The system statuses of the virtual machines form a database for obtaining and retaining a system status of each of the virtual machines. The system status may be obtained as a result of making an inquiry at each virtual machine or may be obtained as a result of making an inquiry at virtualization platform VP100. The system status may be updated based on information obtained from the inquiry.

For example, as shown in FIG. 7, a system status of a virtual machine includes an identifier to identify the virtual machine, a running status of the virtual machine, a system load, a virtual command load, a network status, a traveling state, a traveling mode, and a security anomaly. The running status of the virtual machine indicates whether the virtual machine has been booted up (i.e., is running) or is being stopped. In a case where anomaly responder VM415 restarts the virtual machine, the running status may be used to check whether the restart of the virtual machine has been completed. A system status of a virtual machine is at least one of the following: a traveling state of a vehicle including the monitoring device; a traveling mode of the vehicle; a system load of a virtual machine; a system load in processing a command; a network connection state of the virtual machine; presence or absence of a security anomaly in the virtual machine; or presence or absence of a security anomaly in a virtual command.

The system load is a usage of at least one of a CPU and a memory. The system load may be used to determine to turn ON the detailed monitoring program under a low system load or to turn OFF the detailed monitoring program under a high system load. For example, the system load indicates any one of low, middle, and high system loads. The middle system load indicates a higher system load than the low system load. The high system load indicates a higher system load than the middle system load. The system load is not limited to three levels as described above. The system load may indicate two levels: low and high system loads. In this case, the high system load indicates a higher system load than the low system load.

The virtual command load is a load of processing pertaining to a virtual command. A high virtual command load may be used to determine to invoke a monitoring program in parallel or to cause a plurality of monitoring programs to share processing. A low virtual command load may be determined such that an influence such as delay of a virtual command is minor even in invoking the one or more monitoring programs in series or in invoking the detailed monitoring program. For example, the virtual command load indicates any one of low, middle, and high virtual command loads. The middle system load indicates a higher system load than the low system load. The high system load indicates a higher system load than the middle system load. The virtual command load is not limited to three levels as described above. The system load may indicate two levels: low and high system loads. In this case, the high system load indicates a higher system load than the low system load.

The network status indicates whether the virtual machine has been connected to external equipment for communication (i.e., the communication connection is alive) or not. The network status is shown for only a virtual machine that has a function of communication with external equipment. The network status may be used to determine that the virtual machine is likely to be hacked and determine to turn ON the detailed monitoring program when the network status indicates that the connection has been established.

The traveling state indicates whether the vehicle is traveling or stopping. When the traveling state indicates that the vehicle is traveling, there is an influence on security of communication with control virtual machine VM200, and thus a monitoring program may be invoked in parallel so that the monitoring program does not affect the real-time performance. When the traveling state indicates that the vehicle is stopping, there is no influence on security, and thus a monitoring program need not be invoked. On the other hand, when the traveling state indicates the vehicle is stopping, the system load is low, and thus all the monitoring programs may be invoked.

The traveling mode indicates whether the vehicle is in automated driving or manual driving. When the traveling mode indicates that the vehicle is in the automated driving, there is an influence on security of communication with control virtual machine VM200, and thus a monitoring program may be invoked in parallel so that the monitoring program does not affect the real-time performance. When the traveling mode indicates that the vehicle is in the manual driving, there is no influence on security, and thus a monitoring program need not be invoked.

The security anomaly indicates whether an anomaly pertaining to security has occurred or not (i.e., normality) in the virtual machine. When the simple program determines that an anomaly has occurred, the security anomaly may be used by anomaly responder VM415 to set the virtual machine as being in an anomaly state and may be used to execute the detailed monitoring program in a case of the anomaly state. Note that a security anomaly in each virtual machine may be set based on a result of anomaly determination by another program rather than a result of anomaly determination by the simple program. For example, specific processing is rejected by an access control mechanism of Security-Enhanced Linux (SELinux) or the like in a virtual machine, the virtual machine may be set as being in a security anomaly state.

### [Processing Sequence by Monitoring Virtual Machine]

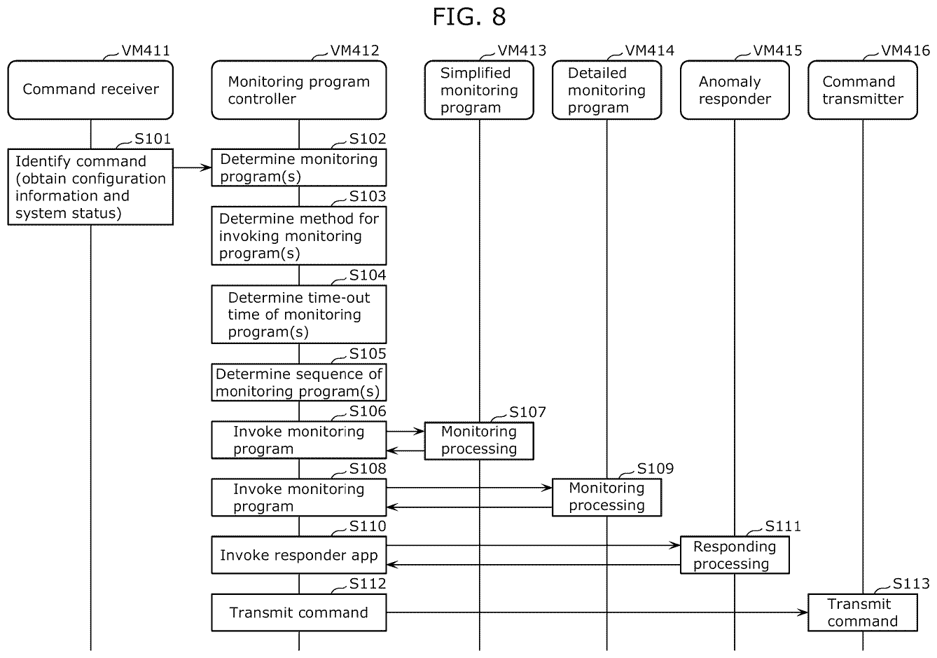

FIG. 8 is a diagram illustrating an example of a processing sequence by a monitoring virtual machine in the embodiment.

As illustrated in FIG. 8, command receiver VM411 receives a command from a virtual machine other than monitoring virtual machine VM400, an external ECU, an external device, or the like and identifies the received command (S101). Thus, system configuration obtainer VM418 obtains configuration information on a virtual machine that has transmitted the command or a virtual machine that has received the command, based on an identifier included in the command. In addition, system status obtainer VM417 may obtain a system status of a virtual machine that has transmitted the command or a virtual machine that has received the command, based on the identifier included in the command. The identifier of the command, the configuration information on the virtual machine, and the system status of the virtual machine obtained in step S101 are reported to monitoring program controller VM412.

Next, monitoring program controller VM412 refers to a feature of the command from the identifier of the command and determines one or more monitoring programs to be executed for the command, according to the reported configuration information and system status, and the feature of the command (S102). Specifically, for each of the one or more monitoring programs to be executed for the received command, monitoring program controller VM412 may determine whether to execute the monitoring program (i.e., whether to turn ON/OFF the monitoring program). For example, monitoring program controller VM412 may determine to execute all of the monitoring programs for a command to external virtual machine VM100, which can have an external connection. For example, monitoring program controller VM412 may execute only one or some of the monitoring programs for a command to image virtual machine VM300 having no external connection and reduce unnecessary processing. For example, monitoring program controller VM412 may determine to execute the simplified monitoring program with only Firewall in reception and may determine to execute the simplified monitoring program and the detailed monitoring program (i.e., Firewall+payload monitoring) in transmission. That is, the monitoring programs to be executed may be changed on a communication basis rather than on a virtual machine basis. For example, monitoring program controller VM412 may execute the one or more monitoring programs on only a command that has an influence on the control of the vehicle and need not execute the one or more monitoring programs on a command that has no influence on the control of the vehicle. In a case where a type of a command is a file operation, monitoring program controller VM412 may change the one or more monitoring programs according to a type of the file operation such as a read request, which has a minor influence on the system, or a write request, which has a major influence on the system. In this manner, it is possible to reduce the processing according to a magnitude of a threat. A specific example of step S102 will be described later. Here, the feature of the command is at least one of the following: a virtual machine at a transmission source or a transmission destination of the command; an electronic control unit at the transmission source or the transmission destination of the command; a transmission direction of the command; an access destination of a file operation included in the command; a type of an operating system (OS) of the virtual machine at the transmission source or the transmission destination; presence or absence of an external connecting function of the virtual machine at the transmission source or the transmission destination; an ASIL of the command; or an influence of the command on vehicle control. The feature of the command may include at least one of the following: a traveling state of a vehicle including the monitoring device; a traveling mode of the vehicle, or a system status.

Next, monitoring program controller VM412 determines a method for invoking (i.e., an invoking mode of) the one or more monitoring programs (S103). For example, monitoring program controller VM412 may determine to invoke the one or more monitoring programs in parallel when the received command is a command to control virtual machine VM200 and determine to invoke the one or more monitoring programs in series when the received command is a command to external virtual machine VM100. Thus, it is possible to immediately respond to an anomaly in communication with no influence of delay. A specific example of step S102 will be described later.

Next, monitoring program controller VM412 determines a time-out time of the one or more monitoring programs (S104). For example, monitoring program controller VM412 may set the time-out time to be short when the received command is a command to control virtual machine VM200 and set the time-out time to be long when the received command is a command to external virtual machine VM100. Thus, it is possible to guarantee a communication delay. A specific example of step S104 will be described later.

Next, monitoring program controller VM412 determines an execution sequence of the one or more monitoring programs (S105). For example, monitoring program controller VM412 may determine to execute the detailed monitoring program (payload monitoring) only when the simplified monitoring program (Firewall) determines an anomaly or may determine to skip the execution of the detailed monitoring program. Thus, it is possible to reduce the number of times monitoring of a high processing load is processed. A specific example of step S105 will be described later.

Next, monitoring program controller VM412 invokes simplified monitoring program VM413, which is determined to be executed out of the one or more monitoring programs (S106). Then, simplified monitoring program VM413 executes monitoring processing (S107).

Next, monitoring program controller VM412 invokes detailed monitoring program VM414, which is determined to be executed out of the one or more monitoring programs (S108). Then, detailed monitoring program VM414 executes monitoring processing (S109).

Next, monitoring program controller VM412 invokes a responder application (S110). Thus, anomaly responder VM415 executes anomaly response processing (S111). In the anomaly response processing, logging the command, dropping the command, restarting the virtual machine, restarting the system, and the like are executed according to a result of the monitoring performed by the monitoring processing. Step S111 will be described later in detail.

Next, monitoring program controller VM412 transmits the received command to command transmitter VM416 to transmit the received command to a virtual machine, an external ECU, an external device, or the like at a designated destination (S112). For example, when the received command is determined to be normal in the monitoring processing, monitoring program controller VM412 transmits the command to command transmitter VM416 to transmit the command to the virtual machine, the external ECU, the external device, or the like at the designated destination. For example, when the received command is determined to be abnormal in the monitoring processing, monitoring program controller VM412 need not transmit the command to command transmitter VM416 to transmit the command to the virtual machine, the external ECU, the external device, or the like at the designated destination. Then, command transmitter VM416 transmits the command received from monitoring program controller VM412 to the virtual machine, the external ECU, the external device, or the like at the designated destination (S113).

### [Determination of Monitoring Program(s)]

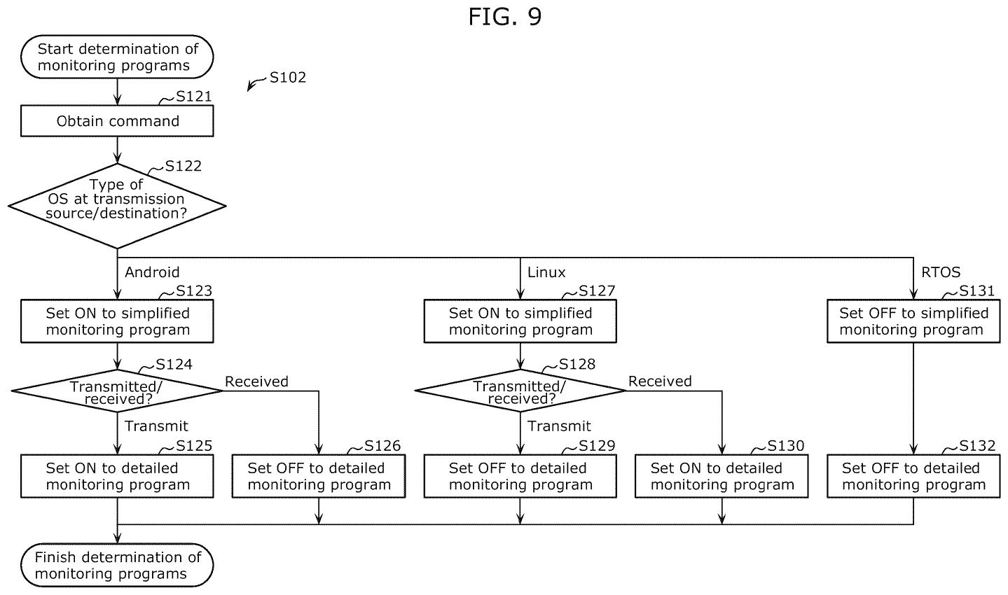

FIG. 9 is a diagram illustrating an example of a flowchart of processing of determining the one or more monitoring programs (S102) in the embodiment. In the processing of determining the one or more monitoring programs, in a case where a target virtual machine is external virtual machine VM100, external virtual machine VM100 is capable of communicating with an outside and is thus highly likely to be hacked from the outside, and thus the one or more monitoring programs may be determined so as to check communication with external virtual machine VM100 in detail. In the processing of determining the one or more monitoring programs, in a case where the target virtual machine is control virtual machine VM200, control virtual machine VM200 is required to have a real-time performance, and thus the monitoring processing by the one or more monitoring programs may be skipped. In the processing of determining the one or more monitoring programs, in a case where the target virtual machine is image virtual machine VM300, image virtual machine VM300 is unlikely to be hacked directly, and thus the detailed monitoring program may be executed on a received command.

As illustrated in FIG. 9, monitoring program controller VM412 obtains the command from command receiver VM411 (S121).

Next, monitoring program controller VM412 determines the type of the OS of the virtual machine at the transmission source or the transmission destination of the obtained command (S122).

When the type of the OS of the virtual machine at the transmission source or the transmission destination of the command is Android (Android in S122), monitoring program controller VM412 executes step S123, when the type of the OS is Linux (registered trademark) (Linux in S122), monitoring program controller VM412 executes step S127, and when the type of the OS is RTOS (RTOS in S122), monitoring program controller VM412 executes step S131.

In step S123, monitoring program controller VM412 sets ON to the simplified monitoring program. That is, the simplified monitoring program is set to be executed.

Next, monitoring program controller VM412 determines whether the command is a transmitted command or a received command (S124).

When the command is a transmitted command (transmitted in S124), monitoring program controller VM412 executes step S125, and when the command is a received command (received in S124), monitoring program controller VM412 executes step S126.

In step S125, monitoring program controller VM412 sets ON to the detailed monitoring program. That is, the detailed monitoring program is set to be executed.

In step S126, monitoring program controller VM412 sets OFF to the detailed monitoring program. That is, the detailed monitoring program is set not to be executed.

In step S127, monitoring program controller VM412 sets ON to the simplified monitoring program. That is, the simplified monitoring program is set to be executed.

Next, monitoring program controller VM412 determines whether the command is a transmitted command or a received command (S128).

When the command is a transmitted command (transmitted in S128), monitoring program controller VM412 executes step S129, and when the command is a received command (received in S128), monitoring program controller VM412 executes step S130.

In step S129, monitoring program controller VM412 sets OFF to the detailed monitoring program. That is, the detailed monitoring program is set not to be executed.

In step S126, monitoring program controller VM412 sets ON to the detailed monitoring program. That is, the detailed monitoring program is set to be executed.

In step S131, monitoring program controller VM412 sets OFF to the simplified monitoring program. That is, the simplified monitoring program is set not to be executed.

Next, monitoring program controller VM412 sets OFF to the detailed monitoring program (S132). That is, the detailed monitoring program is set not to be executed.

In this manner, which of the simplified monitoring program and the detailed monitoring program is to be executed on the obtained command may be determined according to the type of the OS of the virtual machine shown in the command and a transmission-reception status of the command indicating whether the command is a transmitted one or a received one.

Note that ON/OFF of the simplified monitoring program and ON/OFF of the detailed monitoring program may be determined according to at least one of the following: an external network connection state, the traveling state, and the traveling mode. For example, during connection to an external network, a command from external virtual machine VM100 is suspicious, and thus the detailed monitoring program may be set to ON. In addition, while the vehicle is traveling or in the automated driving, a command from the image virtual machine is likely to have an influence on the security, and thus the detailed monitoring program may be set to ON.

### [Invocation of Monitoring Program]

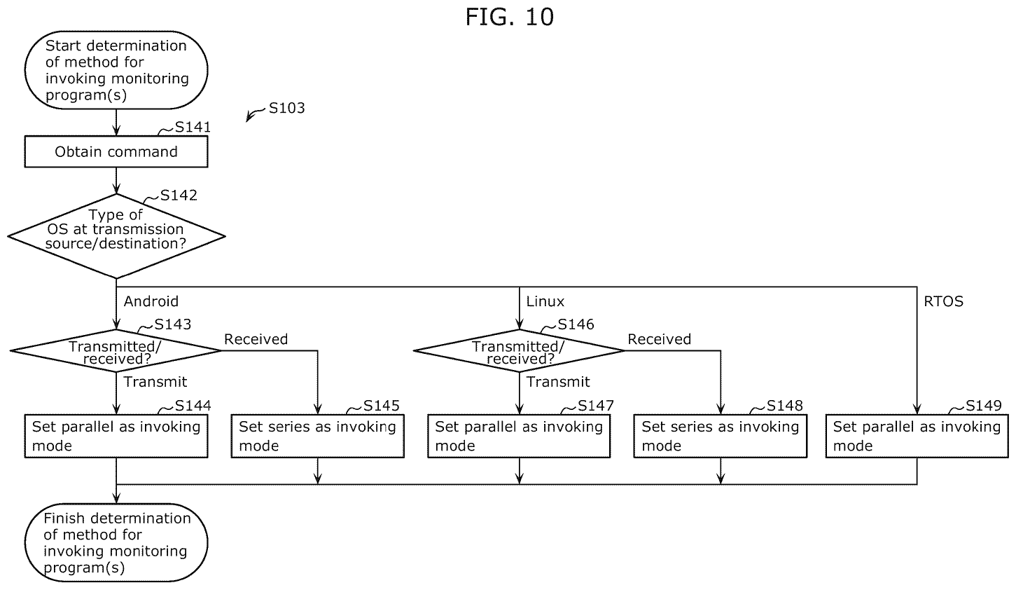

FIG. 10 is a diagram illustrating an example of a flowchart of processing of invoking the one or more monitoring programs (S103) in the embodiment. In the processing of invoking the one or more monitoring programs, in a case where the target virtual machine is external virtual machine VM100, external virtual machine VM100 is capable of communicating with an outside and is thus highly likely to be hacked from the outside, and thus the one or more monitoring programs may be determined so as to check communication with external virtual machine VM100 in detail. In the processing of invoking the one or more monitoring programs, in a case where the target virtual machine is control virtual machine VM200, control virtual machine VM200 is unlikely to be directly hacked, and thus the one or more monitoring programs may be determined so as to check a command received from external virtual machine VM100, an external ECU, an external device, or the like in detail.

As illustrated in FIG. 10, monitoring program controller VM412 obtains the command (S141). Note that step S141 may be omitted because step S141 is the same processing as step S121.

Next, monitoring program controller VM412 determines the type of the OS of the virtual machine at the transmission source or the transmission destination of the obtained command (S142). Note that step S142 may be omitted because step S142 is the same processing as step S122.

When the type of the OS of the virtual machine at the transmission source or the transmission destination of the command is Android (Android in S142), monitoring program controller VM412 executes step S143, when the type of the OS is Linux (Linux in S142), monitoring program controller VM412 executes step S146, and when the type of the OS is RTOS (RTOS in S142), monitoring program controller VM412 executes step S149.

In step S143, monitoring program controller VM412 determines whether the command is a transmitted command or a received command.

When the command is a transmitted command (transmitted in S143), monitoring program controller VM412 executes step S144, and when the command is a received command (received in S143), monitoring program controller VM412 executes step S145.

In step S144, monitoring program controller VM412 sets a parallel invoking mode as the invoking mode of the one or more monitoring programs.

In step S145, monitoring program controller VM412 sets a series invoking mode as the invoking mode of the one or more monitoring programs.

In step S146, monitoring program controller VM412 determines whether the command is a transmitted command or a received command.

When the command is a transmitted command (transmitted in S146), monitoring program controller VM412 executes step S147, and when the command is a received command (received in S146), monitoring program controller VM412 executes step S148.

In step S147, monitoring program controller VM412 sets the parallel invoking mode as the invoking mode of the one or more monitoring programs.

In step S148, monitoring program controller VM412 sets the series invoking mode as the invoking mode of the one or more monitoring programs.

In step S149, monitoring program controller VM412 sets the parallel invoking mode as the invoking mode of the one or more monitoring programs.

When the invoking mode of the one or more monitoring programs is set to be in series, the monitoring processing is executed before the command is transmitted to the transmission destination, and thus it is possible to immediately stop the command when an anomaly is detected. That is, in a case where the one or more monitoring programs are invoked in series, the transmission of the command is stopped until the monitoring processing is finished. In contrast, when the invoking mode of the one or more monitoring programs is set to be parallel, it is possible to transmit the command to the transmission destination without waiting for the monitoring processing on the command.

### [Determination of Time-Out Times of Monitoring Program(s)]

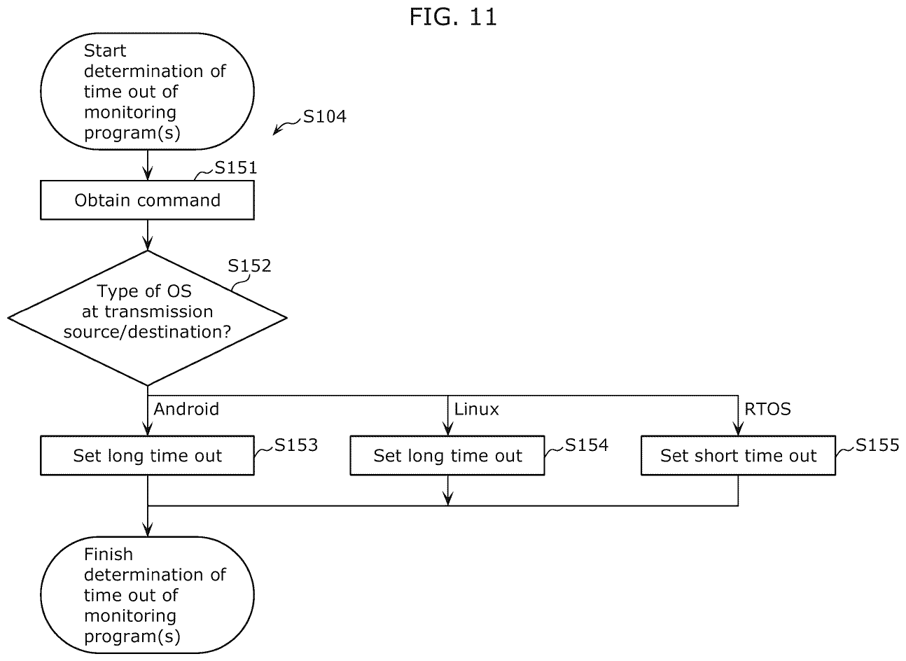

FIG. 11 is a diagram illustrating an example of a flowchart of processing of determining a time-out time of the one or more monitoring programs (S104) in the embodiment. In the processing of determining the time-out time of the one or more monitoring programs, in a case where the virtual machine being monitored is control virtual machine VM200, control virtual machine VM200 is required to have a real-time performance, and thus the time-out time of the monitoring processing by the one or more monitoring programs may be set to be short.

As illustrated in FIG. 11, monitoring program controller VM412 obtains the command (S151). Note that step S151 may be omitted because step S151 is the same processing as step S121 and step S141.

Next, monitoring program controller VM412 determines the type of the OS of the virtual machine at the transmission source or the transmission destination of the obtained command (S152). Note that step S152 may be omitted because step S152 is the same processing as step S122 and step S142.

When the type of the OS of the virtual machine at the transmission source or the transmission destination of the command is Android (Android in S152), monitoring program controller VM412 executes step S153, when the type of the OS is Linux (Linux in S152), monitoring program controller VM412 executes step S154, and when the type of the OS is RTOS (RTOS in S152), monitoring program controller VM412 executes step S155.

In step S153, monitoring program controller VM412 sets the time-out time of the monitoring processing to be long.

In step S154, monitoring program controller VM412 sets the time-out time of the monitoring processing to be long.

In step S155, monitoring program controller VM412 sets the time-out time of the monitoring processing to be short.

When the time-out time is set to be short, maximum delay can be shortened, and thus low delay can be guaranteed, but the monitoring processing may fail to finish successfully. In contrast, when the time-out time is set to be long, the monitoring processing can be a long time, but it takes a long time to transmit the command, and thus the delay may increase.

### [Determination of Monitoring Program(s) (Another Example)]

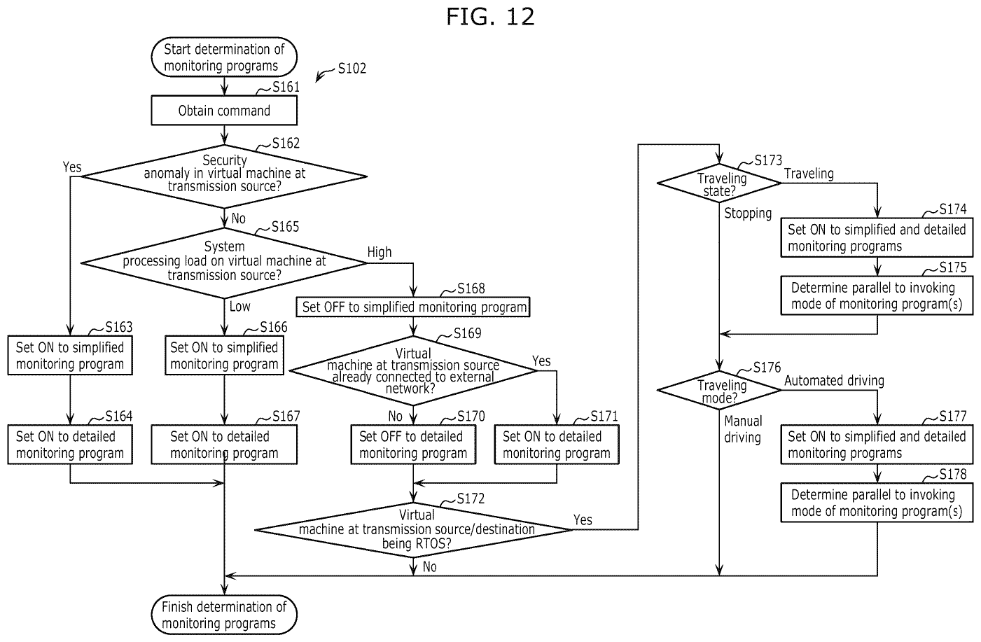

FIG. 12 is a diagram illustrating another example of the flowchart of the processing of determining the one or more monitoring programs (S102) in the embodiment.

As illustrated in FIG. 12, monitoring program controller VM412 obtains the command from command receiver VM411 (S161).

Next, monitoring program controller VM412 determines whether there is a security anomaly in the virtual machine at the transmission source of the obtained command (S162).

When determining that there is a security anomaly in the virtual machine at the transmission source of the obtained command (Yes in S162), monitoring program controller VM412 executes step S163, and when determining that there is no security anomaly in the virtual machine at the transmission source of the obtained command (No in S162), monitoring program controller VM412 executes step S165.

In step S163, monitoring program controller VM412 sets ON to the simplified monitoring program. That is, the simplified monitoring program is set to be executed.

Next, monitoring program controller VM412 sets ON to the detailed monitoring program (S164). That is, the detailed monitoring program is set to be executed.

In step S165, monitoring program controller VM412 determines whether a system processing load of the virtual machine at the transmission source of the obtained command is high or low.

When determining that the system processing load of the virtual machine at the transmission source of the obtained command is low (Low in S165), monitoring program controller VM412 executes step S166, and when determining that the system processing load of the virtual machine at the transmission source of the obtained command is high (High in S165), monitoring program controller VM412 executes step S168.

In step S166, monitoring program controller VM412 sets ON to the simplified monitoring program. That is, the simplified monitoring program is set to be executed.

Next, monitoring program controller VM412 sets ON to the detailed monitoring program (S167). That is, the detailed monitoring program is set to be executed.

In step S168, monitoring program controller VM412 sets OFF to the simplified monitoring program. That is, the simplified monitoring program is set not to be executed.

Next, monitoring program controller VM412 determines whether the virtual machine at the transmission source of the obtained command has been connected to the external network (S169).

When determining that the virtual machine at the transmission source of the obtained command has not been connected to the external network (No in S169), monitoring program controller VM412 executes step S170, and when determining that the virtual machine at the transmission source of the obtained command has been connected to the external network (Yes in S169), monitoring program controller VM412 executes step S171.

In step S170, monitoring program controller VM412 sets OFF to the detailed monitoring program. That is, the detailed monitoring program is set not to be executed.

In step S171, monitoring program controller VM412 sets ON to the detailed monitoring program. That is, the detailed monitoring program is set to be executed.

When step S170 or step S171 is finished, monitoring program controller VM412 determines whether the type of the OS of the virtual machine at the transmission source or the virtual machine at the transmission destination of the obtained command is RTOS (S172).

When the type of the OS of the virtual machine at the transmission source or the virtual machine at the transmission destination of the obtained command is RTOS (Yes in S172), monitoring program controller VM412 executes S173, and when the type of the OS of the virtual machine at the transmission source or the virtual machine at the transmission destination of the obtained command is not RTOS (No in S172), monitoring program VM412 finishes the processing of determining the one or more monitoring programs.

In step S173, monitoring program controller VM412 determines whether the traveling state of the vehicle is traveling or stopping.

When determining that the traveling state of the vehicle is traveling (traveling in S173), monitoring program controller VM412 executes step S174, and when determining that the traveling state of the vehicle is stopping (stopping in S173), monitoring program controller VM412 executes step S176.

In step S174, monitoring program controller VM412 sets ON to the simplified monitoring program and the detailed monitoring program. That is, the simplified monitoring program and the detailed monitoring program are set to be executed.

Next, monitoring program controller VM412 determines the parallel invoking mode as the invoking mode of the one or more monitoring programs (S175). When step S175 is finished, step S176 is executed.

In step S176, monitoring program controller VM412 determines whether the traveling mode of the vehicle is automated driving or manual driving.

When determining that the traveling mode of the vehicle is automated driving (automated driving in S176), monitoring program controller VM412 executes step S177, and when determining that the traveling mode of the vehicle is manual driving (manual driving in S176), monitoring program controller VM412 finishes the processing of determining the one or more monitoring programs.

In step S177, monitoring program controller VM412 sets ON to the simplified monitoring program and the detailed monitoring program. That is, the simplified monitoring program and the detailed monitoring program are set to be executed.

Next, monitoring program controller VM412 determines the parallel invoking mode as the invoking mode of the one or more monitoring programs (S178). When step S178 is finished, the processing of determining the one or more monitoring programs is finished.

### [Determination of Sequence of Monitoring Programs]

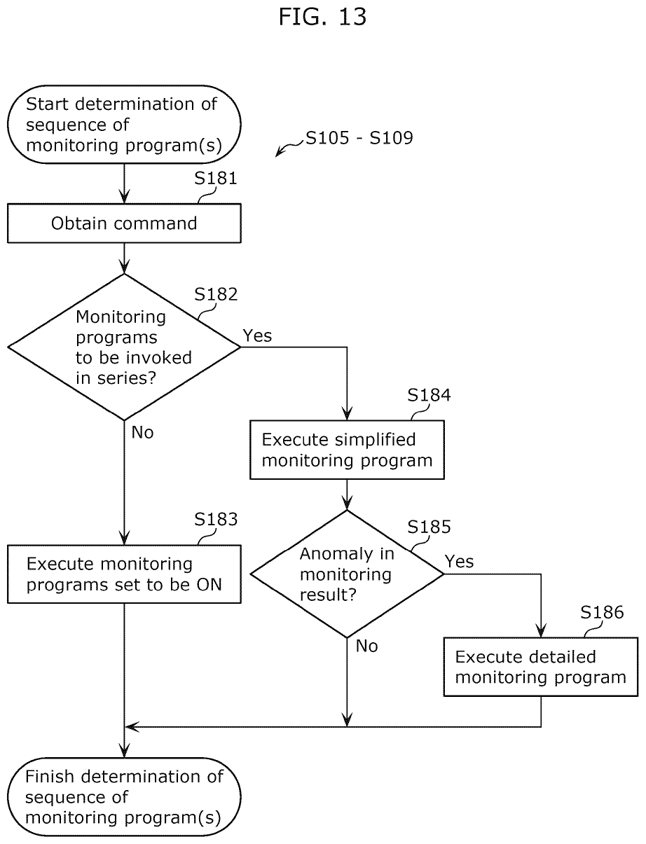

FIG. 13 is a diagram illustrating an example of a flowchart of processing of determining a sequence of the one or more monitoring programs and processing of executing the one or more monitoring programs (S105 to S109) in the embodiment.

As illustrated in FIG. 13, monitoring program controller VM412 obtains the command from command receiver VM411 (S181). Note that step S181 may be omitted because step S181 is the same processing as step S121, step S141, and step S151.

Next, monitoring program controller VM412 determines whether the plurality of monitoring programs are to be invoked in series (S182).

When determining that the plurality of monitoring programs are not to be invoked in series (No in S182), monitoring program controller VM412 executes step S183, and when determining that the plurality of monitoring programs are to be invoked in series (Yes in S182), monitoring program controller VM412 executes step S184. Note that the case where the plurality of monitoring programs are not to be invoked in series includes a case where one monitoring program is to be invoked and a case where the plurality of monitoring programs are to be invoked in parallel.

In step S183, monitoring program controller VM412 executes the one or more monitoring programs set to be ON (at least one of the simplified monitoring program and the detailed monitoring program).

In step S184, monitoring program controller VM412 executes the simplified monitoring program.

Next, monitoring program controller VM412 determines whether a result of the monitoring processing performed by executing the simplified monitoring program indicates an anomaly (S185).

When determining that the result of the monitoring processing performed by executing the simplified monitoring program indicates an anomaly (Yes in S185), monitoring program controller VM412 executes step S186, and when the result of the monitoring processing performed by executing the simplified monitoring program does not indicate an anomaly (i.e., indicates normality) (No in S185), monitoring program controller VM412 finishes the processing of determining the sequence of the one or more monitoring programs.

In step S186, monitoring program controller VM412 executes the detailed monitoring program.

In this manner, by executing the processing of determining the sequence of the one or more monitoring programs, for example, the detailed monitoring program is executed only when the result of the monitoring performed by executing the simplified monitoring program indicates an anomaly, and thus it is possible to detect the anomaly in more detail.

Note that the result of the monitoring performed by executing the simplified monitoring program indicates an anomaly, the execution of the detailed monitoring program may be skipped as the anomaly is confirmed. Thus, it is possible to reduce a time taken to send notice of occurrence of the anomaly.

### [Anomaly Response Processing]

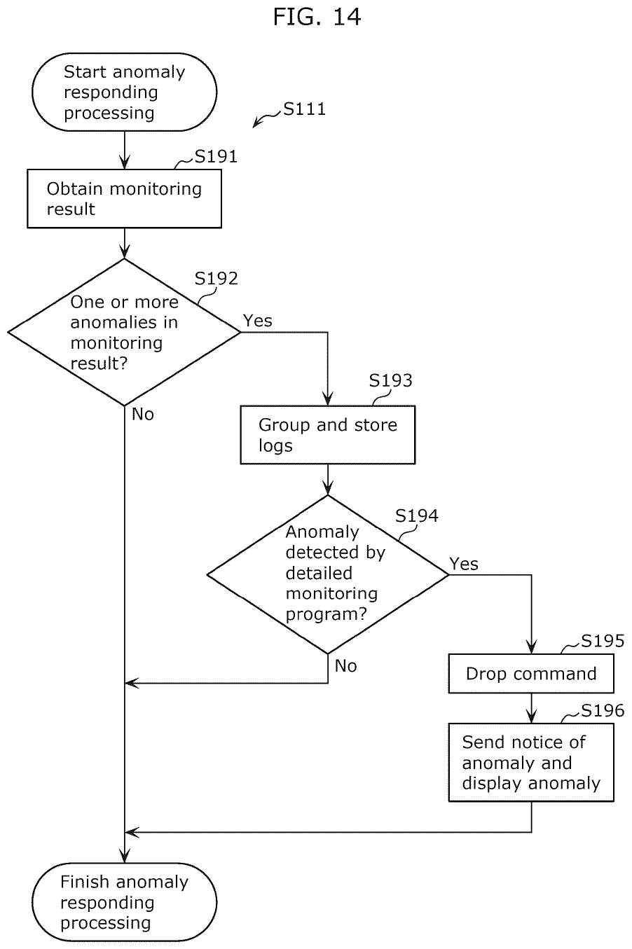

FIG. 14 is a diagram illustrating an example of a flowchart of anomaly response processing (S111) in the embodiment.

As illustrated in FIG. 14, anomaly responder VM415 obtains a result of the monitoring performed by the monitoring processing (S191).

Next, anomaly responder VM415 determines whether the result of the monitoring indicates one or more anomalies or not (S192).

When determining that the result of the monitoring indicates one or more anomalies (Yes in S192), anomaly responder VM415 executes step S193, and when determining that the result of the monitoring does not indicate one or more anomalies, that is, there is no anomaly (No in S192), anomaly responder VM415 finishes the anomaly response processing. Note that necessity of the anomaly response processing may be determined using a threshold value (greater than or equal to one) in this manner, may be determined by means of majority decision, or may be determined by a statistical processing algorithm. In addition, the necessity of the anomaly response processing may be determined with consideration given to at least one of the following: the running status of the virtual machine, the system load, the virtual command load, the network status, the traveling state, the traveling mode, and the security anomaly, which are included in the system status of the virtual machine. Thus, it is possible to implement the anomaly response processing with high reliability and certainty.

In step S193, anomaly responder VM415 groups and stores logs of the result of the monitoring including the one or more anomalies. That is, a grouped log is stored. The grouped log will be described later in detail.

Next, anomaly responder VM415 determines whether the one or more anomalies indicated by the result of the monitoring are one or more anomalies detected by the monitoring processing performed by executing the detailed monitoring program (S194).

When determining that the one or more anomalies indicated by the result of the monitoring are the one or more anomalies detected by the monitoring processing performed by executing the detailed monitoring program (Yes in S194), anomaly responder VM415 executes step S195, and when determining that the one or more anomalies indicated by the result of the monitoring are not the one or more anomalies detected by the monitoring processing performed by executing the detailed monitoring program (i.e., the one or more anomalies are one or more anomalies detected by monitoring processing performed by executing the simplified monitoring program) (No in S194), anomaly responder VM415 finishes the anomaly response processing.

In step S195, anomaly responder VM415 drops the obtained command (i.e., processes the command so as not to use the command). For example, the command may be discarded, or information (a flag) indicating that the command cannot be used may be assigned to the command. The command to which the information (flag) indicating that the command cannot be used is assigned is not used by the virtual machines, the other equipment, and the like.

Next, anomaly responder VM415 sends notice of the one or more anomalies and causes, for example, a virtual machine having the displaying function (image virtual machine VM300) to display a UI including the one or more anomalies that have occurred (S196).

Note that anomaly responder VM415 may drop the command only when the simplified monitoring or the detailed monitoring both determine the command as being abnormal, thus assuring that the command is abnormal.

Anomaly responder VM415 may change a filtering rule of the one or more monitoring programs. Thus, it is possible to drop a command in which an anomaly is detected, from the next time.

Anomaly responder VM415 may restart or stop a virtual machine that is a transmission source of the command with the anomaly. Thus, an attack process can be stopped.

Anomaly responder VM415 may restart the entire system when the number of virtual machines with anomalies is more than a certain number. Thus, it is possible to boot up the system in safety through secure boot.

Anomaly responder VM415 may send notice of the anomaly and display the anomaly. Anomaly responder VM415 may display the anomaly on an in-vehicle display handled by a virtual machine or may send notice of the anomaly to monitoring server 10 to cause monitoring server 10 to display the anomaly.

Anomaly responder VM415 may determine to turn ON/OFF the one or more monitoring programs based on a previous result of the monitoring. In this case, anomaly responder VM415 may set a system status of a virtual machine to be abnormal in security status and set ON/OFF of the one or more monitoring programs according to the system status.

### [Grouped Log]

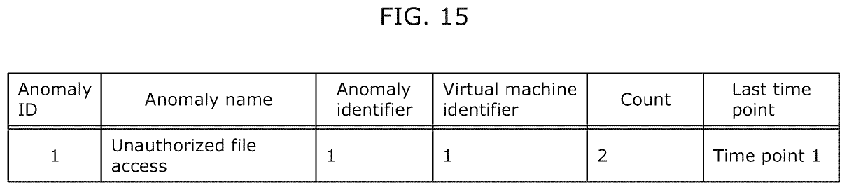

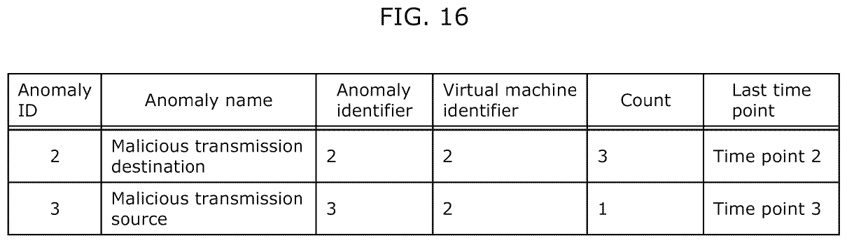

FIG. 15 and FIG. 16 are tables each showing an example of a grouped log in the embodiment.

The grouped log is a log that includes, for each virtual machine, a record of an anomaly included in a command to the virtual machine. As shown in FIG. 15 and FIG. 16, the grouped log includes anomaly ID, anomaly name, anomaly identifier, virtual machine identifier, count, and last time point. The anomaly ID indicates an anomaly with an identical anomaly name and an identical virtual machine being monitored. The anomaly name is a name of a type of an anomaly. The anomaly identifier is information for identifying an anomaly. The virtual machine identifier is information for identifying a virtual machine. The count indicates the number of occurrences of an anomaly with an identical anomaly identifier. The last time point indicates a time point when an anomaly of interest last occurs.

In this manner, with the grouped log, it is possible to extract log information relating to an anomaly detected by monitoring program controller VM412. Thus, anomaly responder VM415 transmitting the grouped log to monitoring server 10 and monitoring server 10 displaying the grouped log on its graphical user interface enable an analyst to perform an analysis efficiently.

In addition, the grouped log may be used by the one or more monitoring programs. For example, the one or more monitoring programs may obtain a grouped log periodically, and when the number of occurrences of anomalies in a specific virtual machine exceeds a threshold value, the one or more monitoring programs may determine the number of occurrences as an anomaly.

FIG. 15 is an example of a grouped log of an anomaly that occurs in a virtual machine with a virtual machine identifier of one. FIG. 16 is an example of a grouped log of an anomaly that occurs in a virtual machine with a virtual machine identifier of two.

### [Display Example of Anomaly in Monitoring Server]

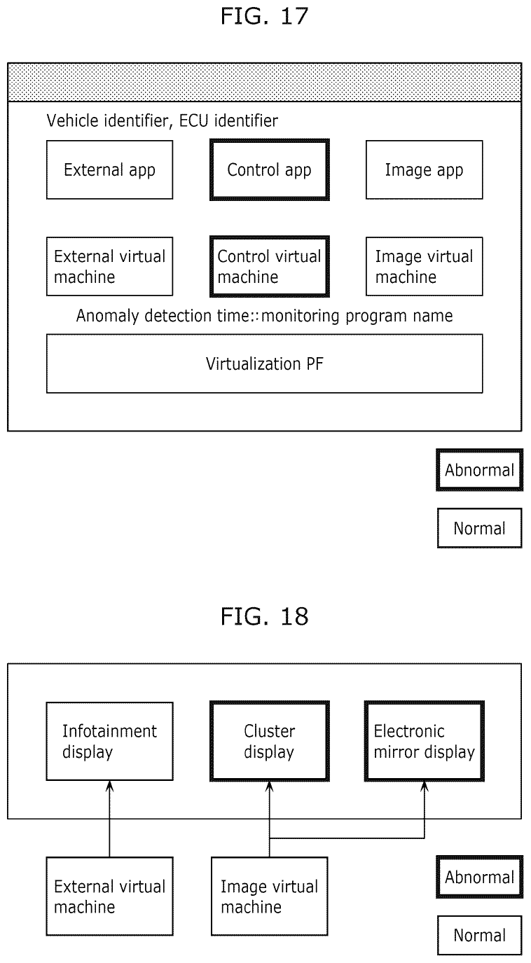

FIG. 17 is a diagram illustrating an example of monitoring result display in the embodiment.

The monitoring result display may be used to convey monitoring information to a security analyst. The monitoring result display may be generated by monitoring server 10 receiving the result of the monitoring from in-vehicle system 20. The monitoring result display is display of the result of the monitoring depicted on the graphical user interface.

When a command is normal, the result of the monitoring includes an identifier to specify a virtual machine corresponding to the command, an identifier of an application corresponding to the virtual machine, and a time point of the determination of the normality. When a command is abnormal, the result of the monitoring includes an identifier to specify a virtual machine corresponding to the command, an identifier of an application corresponding to the virtual machine, and a time point of the determination of the abnormality.

In FIG. 17, blocks enclosed by thick-frames indicate pieces of software being monitored that are determined as being abnormal, and blocks enclosed by thin-frames indicate pieces of software being monitored that are determined as being normal.

FIG. 17 displays an abstracted system architecture of integrated ECU 200 in such a manner as to depict either one or more abnormal constituent elements or one or more normal constituent elements (here, the abnormal constituent elements) in a highlighted and distinguishable manner, and a corresponding result of the monitoring is displayed under the constituent elements. This enables a security analyst to intuitively understand the constituent elements in which an anomaly occurs and to thus perform an analysis of a security anomaly speedily.

A vehicle identifier shown in FIG. 17 is a unique identifier that is assigned to each vehicle. An ECU identifier is an identifier that is assigned to each ECU. In this case, a vehicle identifier of a vehicle in which an anomaly is detected and an identifier of an ECU provided with the virtualization platform are displayed. A transmission source of a command with an anomaly may be displayed in a highlighted manner on a screen displaying the system architecture. In addition, a time point of detecting the anomaly and a name of a monitoring program that detects the anomaly may be displayed. The time point of detecting the anomaly is included in a log of anomaly notice, and the name of the monitoring program is referred to with an identifier included in the log of anomaly notice. This enables a security analyst who analyzes an anomaly with the GUI of the monitoring server to easily locate a spot where the anomaly occurs and to easily grasp details of the anomaly.

### [Display Example of Anomaly in Integrated ECU]

FIG. 18 is a diagram illustrating an example of the monitoring result display in the embodiment.

As illustrated in FIG. 18, frames of display devices controlled by a transmission source of an abnormal communication may be displayed on an in-vehicle display device in a highlighted manner. This enables a driver to easily determine an anomaly and its risk and to stop the vehicle on a shoulder of a road. For example, when there is an anomaly in the image virtual machine, notice of the anomaly may be given by displaying red frames as outer frames of a cluster display device and an electronic mirror display device that are controlled by the image virtual machine.

### Advantageous Effects, Etc.

The monitoring device according to the present embodiment (integrated ECU 200) is a monitoring device in a virtualization platform that causes two or more virtual machines to operate. The monitoring device runs on a first virtual machine that is included in the two or more virtual machines and in which one or more monitoring programs for monitoring a command transmitted or received in a process operate. The monitoring device includes command receiver VM411 that receives a command transmitted or received in a process operating in a second virtual machine different from the first virtual machine, system configuration obtainer VM418 that obtains configuration information on the second virtual machine, monitoring program controller VM412 that refers to a feature of the command from an identifier included in the command and determines an execution method for executing one or more monitoring programs, according to the configuration information and the feature of the command, and anomaly responder VM415 that obtains a result of the monitoring performed by executing the one or more monitoring programs and sends notice of an anomaly when the anomaly is included in the result.

Accordingly, the execution method for executing the one or more monitoring programs is determined according to the configuration information on the second virtual machine and the feature of the command, and thus it is possible to execute monitoring processing appropriate for a feature of the second virtual machine and the feature of the command. Thus, it is possible to adjust a processing load of the monitoring processing. In addition, it is possible to implement monitoring processing with consideration given to a real-time performance of a command and to thus execute the monitoring processing on a command effectively.

A typical command includes only description of L2 physical addresses for transmission and reception, and thus the monitoring program controller cannot obtain another type of address information. Monitoring virtual machine VM400 that is implemented in integrated ECU 200 and monitors a plurality of virtual machines is a monitoring program in a virtualization environment, and thus monitoring virtual machine VM400 can obtain configuration information on virtual machines being monitored and system statuses of the virtual machines being monitored. With these types of information, it is possible to determine a virtual machine (an OS) that originates a communication, from transmission and reception addresses of a command. Furthermore, it is possible to switch processing according to the statuses of the virtual machines.

In the related art, all logs of a result of monitoring are accumulated. However, it takes a long time to perform an analysis for incident response because it is not possible to identify a virtual machine that originates each of the logs. Anomaly responder VM415 according to the present embodiment accumulates an anomaly log for each virtual machine by using configuration information on the virtual machine. Thus, it is possible to reduce the time taken to perform an analysis for incident response. In addition, a virtual machine with an anomaly is identified from a transmission source of a command with an anomaly, and thus it is possible to execute processing for responding to the anomaly such as displaying the anomaly in the virtual machine, restarting the virtual machine, or stopping the virtual machine.

For example, the monitoring device (integrated ECU 200) further includes system status obtainer VM417 that obtains a system status of the second virtual machine. Monitoring program controller VM412 further determines the execution method for executing the one or more monitoring programs, according to the system status.

Accordingly, the execution method for executing the one or more monitoring programs is further determined according to the system status of the second virtual machine, and thus it is possible to execute monitoring processing appropriate for a status of the second virtual machine. Thus, it is possible to adjust a processing load of the monitoring processing. In addition, it is possible to implement monitoring processing with consideration given to a real-time performance of a command and to thus execute the monitoring processing on a command effectively.

For example, the feature of the command is at least one of the following: a virtual machine at a transmission source of the command; a virtual machine at a transmission destination of the command; a transmission direction of the command; a file access; a type of an operating system (OS) of the virtual machine at the transmission source or the transmission destination; an ASIL of the command; a traveling state of a vehicle including the monitoring device; a traveling mode of the vehicle; or a system status of the vehicle. Thus, it is possible to execute monitoring processing appropriate for the feature of the second virtual machine and the feature of the command.

In addition, the execution method for executing the one or more monitoring programs is at least one of the following: whether the one or more monitoring programs are active; a method for invoking the one or more monitoring programs; a time-out time set to the one or more monitoring programs; or an execution sequence of the one or more monitoring programs. Thus, it is possible to adjust a processing load of the monitoring processing. In addition, it is possible to implement monitoring processing with consideration given to a real-time performance of a command.

Anomaly responder VM415 further aggregates or adds up logs each of which indicates an anomaly in a command, according to the type of the command, thus generating a grouped log. Thus, it is possible to use aggregated or added-up anomalies in an analysis.

In addition, based on a result of monitoring performed by executing the simplified monitoring program included in the one or more monitoring programs, monitoring program controller VM412 invokes the detailed monitoring program included in the one or more monitoring programs that has a processing load higher than a processing load of the simplified monitoring program. For example, when an anomaly is detected by the simplified monitoring program, the processing may be performed in such a manner as to execute the detailed monitoring program to obtain a more detailed result about the anomaly. Alternatively, when an anomaly is detected by the simplified monitoring program, the execution of the detailed monitoring program may be skipped to reduce a processing load, thus reducing a time taken to send notice of the anomaly.

### Variation

### [Details of Configuration of Integrated ECU]

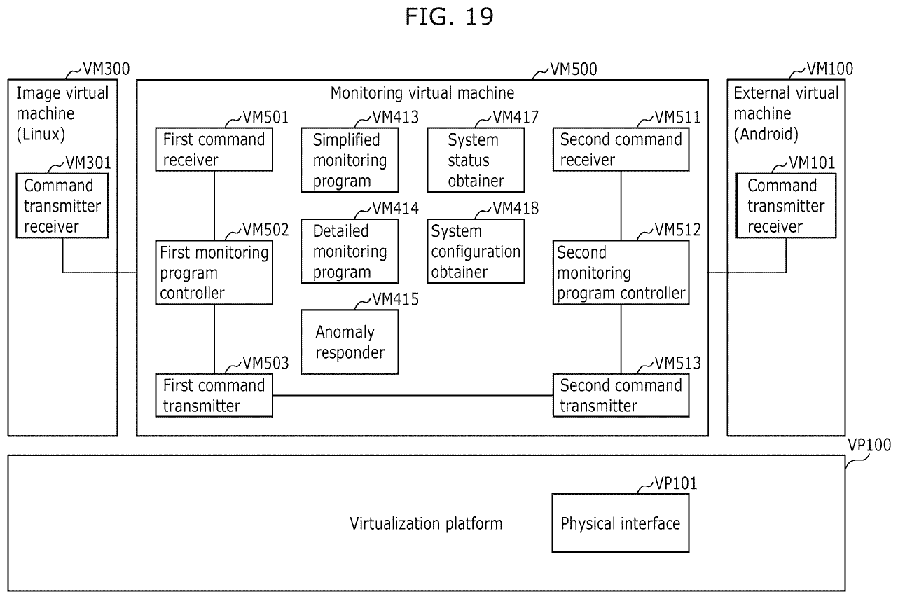

FIG. 19 is a block diagram illustrating a configuration of part of integrated ECU 200 in a variation in detail.

When compared with the embodiment, a configuration of monitoring virtual machine VM500 differs. Thus, monitoring virtual machine VM500 will be described.

Monitoring virtual machine VM500 includes first command receiver VM501, first monitoring program controller VM502, first command transmitter VM503, second command receiver VM511, second monitoring program controller VM512, second command transmitter VM513, simplified monitoring program VM413, detailed monitoring program VM414, anomaly responder VM415, system status obtainer VM417, and system configuration obtainer VM418. Simplified monitoring program VM413, detailed monitoring program VM414, anomaly responder VM415, system status obtainer VM417, and system configuration obtainer VM418 have the same configurations as those included in monitoring virtual machine VM400 in the embodiment, and thus they are denoted by the same reference characters and will not be described.

Monitoring virtual machine VM500 differs from monitoring virtual machine VM400 in the embodiment in that monitoring virtual machine VM500 includes two command receivers, two monitoring program controllers, and two command transmitters. That is, monitoring virtual machine VM500 differs from monitoring virtual machine VM400 in that monitoring virtual machine VM500 includes two sets of command receivers, monitoring program controllers, and command transmitters. Including the two sets of command receivers, monitoring program controllers, and command transmitters, monitoring virtual machine VM500 can restrain a command from delaying by causing the two sets to share a role of the monitoring processing.

First command receiver VM501, first monitoring program controller VM502, and first command transmitter VM503 execute processing for image virtual machine VM300. That is, first command receiver VM501, first monitoring program controller VM502, and first command transmitter VM503 execute processing for a command that is transmitted or received in a process performed by image virtual machine VM300. First command receiver VM501, first monitoring program controller VM502, and first command transmitter VM503 have the same functions as command receiver VM411, monitoring program controller VM412, and command transmitter VM416 in the embodiment, respectively.

Second command receiver VM511, second monitoring program controller VM512, and second command transmitter VM513 execute processing for external virtual machine VM100. That is, second command receiver VM511, second monitoring program controller VM512, and second command transmitter VM513 execute processing for a command that is transmitted or received in a process performed by external virtual machine VM100. Second command receiver VM511, second monitoring program controller VM512, and second command transmitter VM513 have the same functions as command receiver VM411, monitoring program controller VM412, and command transmitter VM416 in the embodiment, respectively.

In a case of an internal communication between virtual machines from image virtual machine VM300 to external virtual machine VM100, first monitoring program controller VM502 may execute the simplified monitoring program and the detailed monitoring program based on settings of the monitoring programs for transmission from image virtual machine VM300. In addition, first monitoring program controller VM502 may execute the simplified monitoring program and the detailed monitoring program based on settings of the monitoring programs for reception from external virtual machine VM100.

In this case, it is inefficient to execute the same monitoring programs on the same command twice. Thus, the monitoring processing is executed by one monitoring program controller of first monitoring program controller VM502 and second monitoring program controller VM512, or the processing is shared by both first monitoring program controller VM502 and second monitoring program controller VM512. The sharing of the processing is determined based on a sharing table, and the processing is shared in such a manner that the simplified monitoring program is executed by a monitoring program controller corresponding to a virtual machine that transmits a command, and the detailed monitoring program is executed by a monitoring program controller corresponding to a virtual machine that receives the command. The delay is thereby reduced.

### [Processing Sequence by Monitoring Virtual Machine]

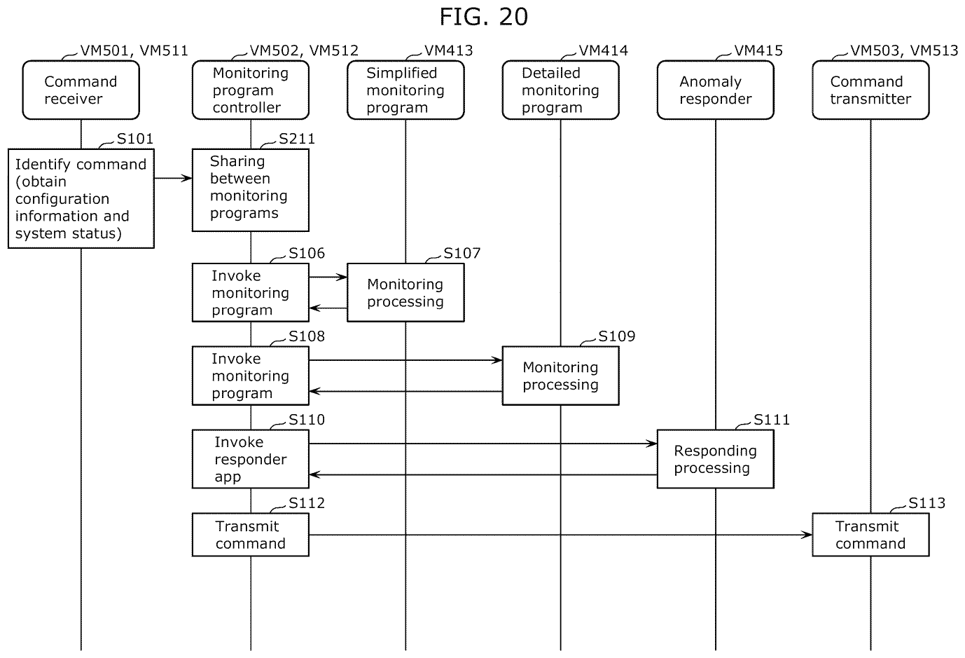

FIG. 20 is a diagram illustrating an example of a processing sequence by a monitoring virtual machine in the variation.

As illustrated in FIG. 20, first command receiver VM501 or second command receiver VM511 receives a command from a virtual machine other than monitoring virtual machine VM500, an external ECU, an external device, or the like and identifies the received command (S101). Thus, system configuration obtainer VM418 obtains configuration information on a virtual machine that has transmitted the command or a virtual machine that has received the command, based on an identifier included in the command. In addition, system status obtainer VM417 may obtain a system status of a virtual machine that has transmitted the command or a virtual machine that has received the command, based on the identifier included in the command. The identifier of the command, the configuration information on the virtual machine, and the system status of the virtual machine obtained in step S101 are reported to first monitoring program controller VM502 and second monitoring program controller VM512.

Next, first monitoring program controller VM502 and second monitoring program controller VM512 refer to a feature of the command from the identifier of the command and determine the sharing between the monitoring programs, according to the reported configuration information and system status, and the feature of the command (S211). For example, first monitoring program controller VM502 and second monitoring program controller VM512 share the monitoring processing in such a manner as to execute the monitoring processing at an interface having a lower system load. The load can be thereby reduced.

Next, first monitoring program controller VM502 and second monitoring program controller VM512 invoke simplified monitoring program VM413, which is determined to be executed out of the one or more monitoring programs (S106). Then, simplified monitoring program VM413 executes monitoring processing (S107).

Next, first monitoring program controller VM502 and second monitoring program controller VM512 invoke detailed monitoring program VM414, which is determined to be executed out of the one or more monitoring programs (S108). Then, detailed monitoring program VM414 executes monitoring processing (S109).

Next, first monitoring program controller VM502 and second monitoring program controller VM512 invoke the responder application (S110). Thus, anomaly responder VM415 executes anomaly response processing (S111). In the anomaly response processing, logging the command, dropping the command, restarting the virtual machine, restarting the system, and the like are executed according to a result of the monitoring performed by the monitoring processing. Step S111 will be described later in detail.

Next, first monitoring program controller VM502 and second monitoring program controller VM512 transmit the received command to first command transmitter VM503 or second command transmitter VM513 to transmit the received command to a virtual machine, an external ECU, an external device, or the like at a designated destination (S112). For example, when the received command is determined to be normal in the monitoring processing, first monitoring program controller VM502 and second monitoring program controller VM512 transmit the command to a command transmitter corresponding to a transmission destination to transmit the command to the virtual machine, the external ECU, the external device, or the like at the designated destination. For example, when the received command is determined to be abnormal in the monitoring processing, first monitoring program controller VM502 and second monitoring program controller VM512 need not transmit the command to a command transmitter corresponding to a transmission destination to transmit the command to the virtual machine, the external ECU, the external device, or the like at the designated destination. Then, the command corresponding to the transmission destination transmits the command received from first monitoring program controller VM502 and second monitoring program controller VM512 to the virtual machine, the external ECU, the external device, or the like at the designated destination (S113).

Although first monitoring program controller VM502 and second monitoring program controller VM512 are supposed to perform the processes of steps S211, S106, S108, S110, and S112 in the above description, these processes may be performed by at least one of first monitoring program controller VM502 and second monitoring program controller VM512.

### [Sharing Between Monitoring Programs]

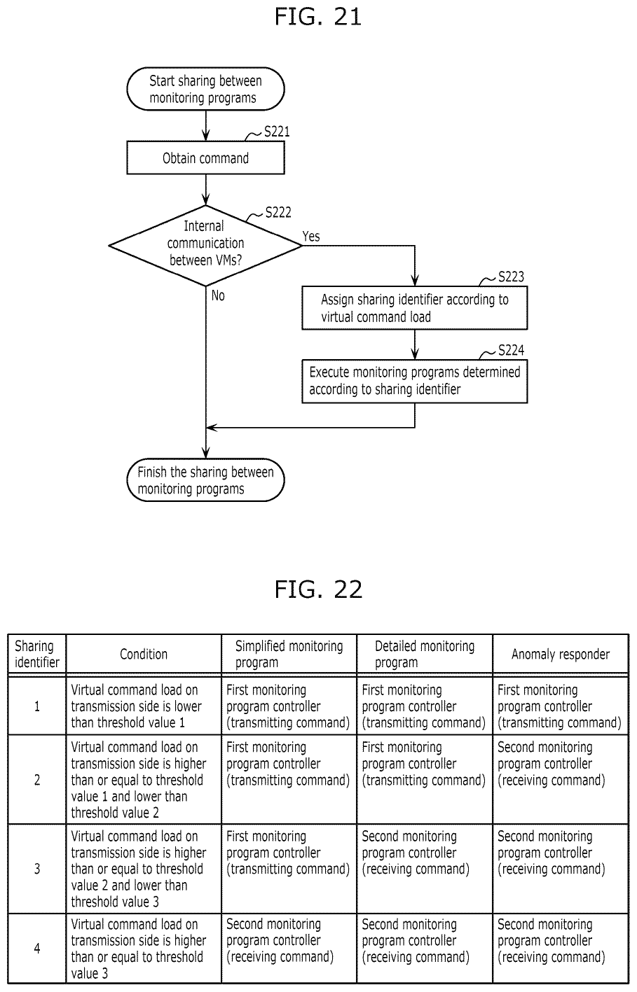

FIG. 21 is a diagram illustrating an example of a flowchart of processing for the sharing between the monitoring programs (S211) in the variation.

As illustrated in FIG. 21, first monitoring program controller VM502 or second monitoring program controller VM512 obtains the command received by first command receiver VM501 or second command receiver VM511 (S221).

Next, based on the obtained command, first monitoring program controller VM502 or second monitoring program controller VM512 determines whether the command is of an internal communication between virtual machines (S222). That is, first monitoring program controller VM502 or second monitoring program controller VM512 determines whether a transmission source and a transmission destination of the obtained command are both virtual machines.

When determining that the command is of the internal communication between virtual machines (Yes in S222), first monitoring program controller VM502 or second monitoring program controller VM512 executes step S223, and when determining that the command is not of the internal communication between virtual machines (No in S222), first monitoring program controller VM502 or second monitoring program controller VM512 finishes the processing for the sharing between the monitoring programs.

In step S223, first monitoring program controller VM502 or second monitoring program controller VM512 refers to a determination table for the sharing according to a virtual command load and assigns a sharing identifier.

Next, first monitoring program controller VM502 or second monitoring program controller VM512 executes a monitoring program that is determined according to the sharing identifier (S224).

### [Determination Table for Sharing]

FIG. 22 is a table showing an example of a determination table for the sharing in the variation.

As shown in FIG. 22, the determination table for the sharing includes sharing identifier, condition, monitoring program controller to execute the simplified monitoring program, monitoring program controller to execute the detailed monitoring program, and anomaly responder. The sharing identifier is an identifier to specify one of four sharing methods. The condition is a condition for determining one of the four sharing methods based on a virtual command load. For example, when a virtual command load on a transmission side is lower than threshold value 1, the simplified monitoring program is executed by first monitoring program controller VM502, the detailed monitoring program is executed by first monitoring program controller VM502, and the anomaly response processing is executed by first monitoring program controller VM502. For example, when the virtual command load on the transmission side is higher than or equal to threshold value 1 and lower than threshold value 2, the simplified monitoring program is executed by first monitoring program controller VM502, the detailed monitoring program is executed by first monitoring program controller VM502, and the anomaly response processing is executed by second monitoring program controller VM512. For example, when the virtual command load on the transmission side is higher than or equal to threshold value 2 and lower than threshold value 3, the simplified monitoring program is executed by first monitoring program controller VM502, the detailed monitoring program is executed by second monitoring program controller VM512, and the anomaly response processing is executed by second monitoring program controller VM512. For example, when the virtual command load on the transmission side is higher than or equal to threshold value 3, the simplified monitoring program is executed by second monitoring program controller VM512, the detailed monitoring program is executed by second monitoring program controller VM512, and the anomaly response processing is executed by second monitoring program controller VM512.

Although FIG. 22 shows a method for specifying the one of the sharing methods according to the virtual command load, the one of the sharing methods may be specified according to a communication direction of the virtual command, a transmission destination, or a transmission source. For example, the simplified monitoring program and the detailed monitoring program are executed by first monitoring program controller VM502 that receives the virtual command, and the anomaly response processing is executed by second monitoring program controller VM512 that transmits the virtual command. In this case, it is possible to determine the one of the sharing methods without referring to the virtual command load.

Alternatively, first monitoring program controller VM502 may assign a sharing identifier to a virtual command, and second monitoring program controller VM512 may refer to the sharing identifier assigned to the virtual command to specify the one of the sharing methods. In this case, first monitoring program controller VM502 can arbitrarily determine the one of the sharing methods. Note that, rather than the method of assigning a sharing identifier to a virtual command, the method for the sharing between the monitoring programs may be specified through data communication or data sharing between first monitoring program controller VM502 and second monitoring program controller VM512, or the method for the sharing between the monitoring programs may be specified through data communication or data sharing between the monitoring programs. In this case, it is possible to dynamically determine the one of the sharing methods according to a feature of the virtual command and features of the monitoring programs.

Alternatively, in a case where the monitoring programs retain a plurality of monitoring rules, such sharing that a first rule is applied to a monitoring program executed by first monitoring program controller VM502, and that a monitoring program executed by second monitoring program controller VM512 applies a second rule may be performed. In this case, it is possible to share the processing even when the number of the monitoring programs is one.

### Advantageous Effects, Etc.

The monitoring device according to the variation (integrated ECU 200) includes two or more monitoring program controllers (e.g., first monitoring program controller VM502 and second monitoring program controller VM512). When the transmission destination of the command is determined to be a virtual machine on the virtualization platform, the execution method for executing the one or more monitoring programs on the command is determined by, among the two or more monitoring program controllers, one or more monitoring program controllers determined based on an identifier included in the command and the configuration information.

For example, the two or more monitoring program controllers determine the execution method for executing the one or more monitoring programs, according to the system status.

For example, among the two or more monitoring program controllers, the first monitoring program controller assigns a first identifier to a command, and the second monitoring program controller determines the execution method for executing the one or more monitoring programs, according to whether the first identifier has been assigned to the command.

Thus, it is possible to cause the two or more monitoring program controllers to share the monitoring processing, based on the identifier included in the command and the configuration information. Therefore, the delay can be reduced.

Although the monitoring device according to the present disclosure has been described based on the above-described embodiment and the variation thereof, the present disclosure is not limited to the embodiment and the variation. Forms obtained by various modifications to each of the above-described embodiment and the variation that can be conceived by a person skilled in the art may be included in the scope of the present disclosure as long as they do not depart from the essence of the present disclosure.

It should be noted that, in the above-described embodiment, the respective constituent elements may be configured using dedicated hardware or may also be implemented by executing software programs suited to the respective constituent elements. The respective constituent elements may be implemented by a program execution unit such as a center processing unit (CPU) or a processor reading and executing a software program recorded on a recording medium such as a hard disk or semiconductor memory. Here, the software for implementing the monitoring device etc. according to each of the above-described embodiments is a computer program for causing a computer to execute each of the steps in the flow chart or sequence diagram shown in each of FIG. 8 to FIG. 14, FIG. 20, and FIG. 21.

It should be noted that the following cases are also included in the present disclosure.
(1) At least one device described above is specifically a computer system that includes, for example, a microprocessor, a ROM, a RAM, a hard disk unit, a display unit, a keyboard, and a mouse. The RAM or the hard disk unit stores computer programs. The at least one device described above achieves its functions by the microprocessor operating in accordance with the computer programs. The computer programs as used herein refer to those configured by combining a plurality of instruction codes that indicate commands given to the computer in order to achieve predetermined functions.
(2) Some or all of the constituent elements included in the at least one device described above may also be made up of a single-system large scale integrated (LSI) circuit. The system LSI circuit is an ultra-multifunctional LSI circuit manufactured by integrating a plurality of components on a single chip, and is specifically a computer system that includes, for example, a microprocessor, a ROM, and a RAM. The RAM stores computer programs. The system LSI achieves its functions by the microprocessor operating in accordance with the computer programs.
(3) Some or all of the constituent elements included in the at least one device described above may also be configured as an IC card or a stand-alone module that is detachable from the device. The IC card or the module is a computer system that includes, for example, a microprocessor, a ROM, and a RAM. The IC card or the module may also be configured to include the ultra-multifunction LSI described above. The IC card or the module achieves its functions by the microprocessor operating in accordance with computer programs. The IC card or the module may have protection against tempering.
(4) The present disclosure may also be implemented as the methods described above. The present disclosure may also be implemented as a computer program for causing a computer to execute the methods described above, or may be implemented as digital signals of the computer programs.

Moreover, the present disclosure may also be implemented by recording computer programs or digital signals on a computer-readable recording medium such as a flexible disk, a hard disk, a compact-disc (CD)-ROM, a DVD, a DVD-ROM, a DVD-RAM, a Blu-ray (registered trademark) disk (BD), or semiconductor memory. In addition, the present disclosure may be implemented as the digital signals recorded on the recording medium as described above.

Furthermore, the present disclosure may also be implemented by transmitting computer programs or digital signals via, for example, telecommunication lines, wireless or wired communication lines, a network represented by the Internet, or data broadcasting.

Moreover, the present disclosure may also be implemented as another independent computer system by transferring programs or digital signals that are recorded on a recording medium, or by transferring programs or digital signals via the network or the like.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2022-094337 filed on Jun. 10, 2022, and PCT International Application No. PCT/JP2023/004470 filed on Feb. 9, 2023.

### INDUSTRIAL APPLICABILITY

The monitoring device according to the present disclosure is applicable to, for example, electronic equipment provided in a vehicle.

1. A monitoring device in a virtualization platform that causes two or more virtual machines to operate,
wherein the monitoring device runs on a first virtual machine in which one or more monitoring programs operate, the first virtual machine being included in the two or more virtual machines, the one or more monitoring programs being for monitoring a command transmitted or received in a process,
the monitoring device comprises:
a processor; and
a non-transitory memory in which a program is stored, and
the processor executes the program to cause the monitoring device to operate as:
a command receiver that receives a command transmitted or received in a process operating in a second virtual machine different from the first virtual machine;
a configuration information obtainer that obtains configuration information on the second virtual machine;
a monitoring program controller that refers to a feature of the command from an identifier included in the command, and determines an execution method for executing the one or more monitoring programs, according to the configuration information and the feature of the command; and
an anomaly responder that obtains a result of the monitoring performed by executing the one or more monitoring programs, and sends notice of an anomaly when the anomaly is included in the result.

2. The monitoring device according to claim 1,
wherein the processor further causes the monitoring device to operate as a system status obtainer that obtains a system status of the second virtual machine, and
the monitoring program controller further determines the execution method for executing the one or more monitoring programs, according to the system status.

3. The monitoring device according to claim 1,
wherein the feature of the command is at least one of the following: a virtual machine at a transmission source or a transmission destination of the command; an electronic control unit at the transmission source or the transmission destination of the command; a transmission direction of the command; an access destination of a file operation included in the command; a type of the file operation included in the command; a type of an operating system (OS) of the virtual machine at the transmission source or the transmission destination; presence or absence of an external connecting function of the virtual machine at the transmission source or the transmission destination; an automotive safety integrity level (ASIL) of the command; or an influence of the command on vehicle control.

4. The monitoring device according to claim 2,
wherein the system status is at least one of the following: a traveling state of a vehicle including the monitoring device; a traveling mode of the vehicle; a system load of a virtual machine; a system load in processing the command; a network connection state of the virtual machine; presence or absence of a security anomaly in the virtual machine; or presence or absence of a security anomaly in a virtual command.

5. The monitoring device according to claim 1,
wherein the execution method for executing the one or more monitoring programs is at least one of the following: whether the one or more monitoring programs are active; a method for invoking the one or more monitoring programs; a time-out time set to the one or more monitoring programs; or an execution sequence of the one or more monitoring programs.

6. The monitoring device according to claim 1,
wherein the anomaly responder further aggregates or adds up logs each of which indicates an anomaly in the command, according to the feature of the command.

7. The monitoring device according to claim 1,
wherein, based on a result of monitoring performed by executing a simplified monitoring program, the monitoring program controller invokes a detailed monitoring program that has a processing load higher than a processing load of the simplified monitoring program, the simplified monitoring program and the detailed monitoring program being included in the one or more monitoring programs.

8. The monitoring device according to claim 1,
wherein the processor further causes the monitoring device to operate as two or more monitoring program controllers, the two or more monitoring program controllers each being the monitoring program controller, and
when a transmission destination of the command is determined to be a virtual machine on the virtualization platform, the execution method for executing the one or more monitoring programs is determined by, among the two or more monitoring program controllers, one or more monitoring program controllers determined based on the identifier included in the command and the configuration information.

9. The monitoring device according to claim 8,
wherein the two or more monitoring program controllers determine the execution method for executing the one or more monitoring programs, according to a system status of the second virtual machine.

10. The monitoring device according to claim 8,
wherein, among the two or more monitoring program controllers, a first monitoring program controller assigns a first identifier to the command, and a second monitoring program controller determines the execution method for executing the one or more monitoring programs, according to whether the first identifier has been assigned to the command.

11. A monitoring method to be executed by a monitoring device in a virtualization platform that causes two or more virtual machines to operate,
wherein the monitoring device runs on a first virtual machine in which one or more monitoring programs operate, the first virtual machine being included in the two or more virtual machines, the one or more monitoring programs being for monitoring a command transmitted or received in a process,
the monitoring method comprises:
receiving a command transmitted or received in a process operating in a second virtual machine different from the first virtual machine;
obtaining configuration information on the second virtual machine;
referring to a feature of the command from an identifier included in the command, and determining an execution method for executing the one or more monitoring programs, according to the configuration information and the feature of the command; and
obtaining a result of the monitoring performed by executing the one or more monitoring programs, and sending notice of an anomaly when the anomaly is included in the result.
